(19) United States
(12) Patent Application Publication
(10) Pub. No.: US 2014/0366717 A1
(43) Pub. Date: Dec. 18, 2014

(54) FLUID PRESSURE INCREASING/DECREASING MACHINE AND WORKING MACHINE

(71) Applicant: SUMITOMO HEAVY INDUSTRIES, LTD., Tokyo (JP)

(72) Inventor: Koichiro TSUKANE, Kanagawa (JP)

(21) Appl. No.: 14/478,035

(22) Filed: Sep. 5, 2014

Related U.S. Application Data
(63) Continuation of application No. PCT/JP2013/052728, filed on Feb. 6, 2013.

(30) Foreign Application Priority Data
Mar. 23, 2012 (JP) 2012-068369
Mar. 23, 2012 (JP) 2012-068370

(51) Int. Cl. F15B 15/14

(52) U.S. Cl. CPC F15B 15/14
USPC 92/62

(57) ABSTRACT

A fluid pressure increasing/decreasing machine can continuously supply an output pressure to a destination of supply by converting an input pressure from a source of supply. A control device selects at least one input pressure chamber and at least one output pressure chamber from among at least three pressure chambers in a fluid pressure cylinder or a plurality of fluid pressure cylinders operating inter-connectedly, the input pressure chamber being supplied with the input pressure, the output pressure chamber creating the output pressure including a pressure higher than the input pressure and a pressure lower than the input pressure. A flow control valve causes the selected input pressure chamber to communicate with the source of supply, and the selected output pressure chamber to communicate with the destination of supply. At least one of the pressure chambers is capable of being either of the input pressure chamber and the output pressure chamber.

### CROSS-REFERENCE TO RELATED APPLICATION

The present application is a continuation application filed under 35 U.S.C. 111(a) claiming benefit under 35 U.S.C. 120 and 365(c) of PCT International Application No. PCT/JP2013/052728 filed on Feb. 6, 2013, designating the U.S., which claims priority based on Japanese Patent Applications No. 2012-068369 and No. 2012-068370 filed on Mar. 23, 2012. The entire contents of each of the foregoing applications are incorporated herein by reference.

### BACKGROUND

1. Technical Field

The present invention relates to a fluid pressure increasing/decreasing machine using a fluid-pressure cylinder and a working machine equipped with a fluid pressure increasing/decreasing machine.

2. Description of Related Art

Conventionally, there is known a high-pressure water supplying apparatus, which creates high-pressure water using low-pressure air. In the high-pressure water supplying apparatus, a piston of a primary-side pneumatic actuator and a piston of a secondary-side water-pressure actuator are coupled to each other by a single piston rod so as to enable the primary-side pneumatic actuator and the secondary-side water-pressure actuator to operate inter-connectedly. Then, by reciprocally sliding the piston of the primary-side pneumatic actuator by low-pressure air, the piston of the secondary-side water-pressure actuator is reciprocally slid simultaneously so as to be capable of continuously creating high-pressure water from the low-pressure air at a fixed pressure conversion ratio.

### SUMMARY

There is provided according an aspect of the invention a fluid pressure increasing/decreasing machine capable of continuously supplying an output pressure to an external destination of supply by converting an input pressure supplied from an external source of supply, the fluid pressure increasing/decreasing machine including: a control device selecting at least one input pressure chamber and at least one output pressure chamber from among at least three pressure chambers in a fluid pressure cylinder or a plurality of fluid pressure cylinders operating inter-connectedly, the input pressure chamber being supplied with the input pressure, the output pressure chamber creating the output pressure including a pressure higher than the input pressure and a pressure lower than the input pressure; and a flow control valve controlled by the control device to cause the selected input pressure chamber to communicate with the external source of supply, and cause the selected output pressure chamber to communicate with the external destination of supply, wherein at least one of the pressure chambers is capable of being either of the input pressure chamber and the output pressure chamber.

There is provided according to another aspect of the invention a working machine including: a main cylinder driving a work body; an assist cylinder assisting the main cylinder; an accumulator recovering a potential energy of the work body as a fluid pressure energy, and allowing the recovered fluid pressure energy to be used for driving the assist cylinder; and a fluid pressure increasing/decreasing machine capable of continuously supplying an output pressure to an external destination of supply by converting an input pressure supplied from an external source of supply, the fluid pressure increasing/decreasing machine including: a control device selecting at least one input pressure chamber and at least one output pressure chamber from among at least three pressure chambers in a fluid pressure cylinder or a plurality of fluid pressure cylinders operating inter-connectedly, the input pressure chamber being supplied with the input pressure, the output pressure chamber creating the output pressure including a pressure higher than the input pressure and a pressure lower than the input pressure; and a flow control valve controlled by the control device to cause the selected input pressure chamber to communicate with the external source of supply, and cause the selected output pressure chamber to communicate with the external destination of supply, wherein at least one of the pressure chambers is capable of being either of the input pressure chamber and the output pressure chamber, and the fluid pressure increasing/deceasing machine sets the accumulator as the external source of supply and sets the assist cylinder as the external destination of supply.

There is provided according to a further aspect of the invention a fluid pressure increasing/decreasing machine capable of continuously supplying an output pressure to an external destination of supply by converting an input pressure supplied from an external source of supply, the fluid pressure increasing/decreasing machine including: a control device selecting at least one input pressure chamber, at least one output pressure chamber and at least one different pressure chamber from among at least three pressure chambers in a fluid pressure cylinder or a plurality of fluid pressure cylinders operating inter-connectedly, the input pressure chamber being supplied with the input pressure, the output pressure chamber creating the output pressure including a pressure higher than the input pressure and a pressure lower than the input pressure, the different pressure chamber being supplied with a pressure different from the input pressure and the output pressure; and a flow control valve controlled by the control device to cause the selected input pressure chamber to communicate with the external source of supply, and cause the selected output pressure chamber to communicate with the external destination of supply, wherein at least one of the pressure chambers is capable of being either of the input pressure chamber and the output pressure chamber.

### BRIEF DESCRIPTION OF THE DRAWINGS

FIG. 1 is a hydraulic circuit diagram illustrating a structure of a hydraulic pressure increasing/decreasing machine according to an embodiment of the present invention;

FIG. 2 is a diagram illustrating an operational state of the hydraulic circuit diagram of FIG. 1;

FIG. 3 is a diagram illustrating another operational state of the hydraulic circuit diagram of FIG. 1;

FIG. 4 is a diagram illustrating a further operational state of the hydraulic circuit diagram of FIG. 1;

FIG. 5 is a hydraulic circuit diagram illustrating another structure of the hydraulic pressure increasing/decreasing machine according to the embodiment of the present invention;

FIG. 6 is a hydraulic circuit diagram illustrating a further structure of the hydraulic pressure increasing/decreasing machine according to the embodiment of the present invention.

FIG. 7A is an enlarged view of hydraulic cylinders and a piston rod of the hydraulic pressure increasing/decreasing machine illustrated in FIG. 1;

FIG. 7B is a specification table illustrating the detail of the hydraulic cylinders;

FIG. 7C is a specification table illustrating the detail of pressure conversion ratios that are achievable by the hydraulic pressure increasing/decreasing machine;

FIG. 7D is a graph indicating a relationship between the pressure conversion ratio and the number of stages illustrated in FIG. 7C;

FIG. 8 is an illustration for explaining a distribution of the pressure conversion ratio;

FIGS. 9A through 9C are illustrations for explaining a relationship between pressure-receiving areas of each pressure chamber of a hydraulic actuator in the hydraulic pressure increasing/decreasing machine according to the embodiment of the present invention;

FIGS. 10A through 100 are cross-sectional views of the hydraulic actuator having other structures;

FIG. 11 is an outline side view of a shovel according to the embodiment of the present invention;

FIG. 12 is a hydraulic circuit diagram of a hydraulic pressure increasing/decreasing machine mounted on the shovel of FIG. 11;

FIG. 13 is a flowchart of a stage determination process;

FIG. 14 is an illustration indicating an example of a relationship between a stroke amount of an assist cylinder, an input pressure and an output pressure of the hydraulic pressure increasing/decreasing machine and a number of stages used in the hydraulic pressure increasing/decreasing machine;

FIG. 15 is an illustration indicating another example of a relationship between a stroke amount of an assist cylinder, an input pressure and an output pressure of the hydraulic pressure increasing/decreasing machine and a number of stages used in the hydraulic pressure increasing/decreasing machine;

FIG. 16 is an illustration indicating a further example of a relationship between a stroke amount of an assist cylinder, an input pressure and an output pressure of the hydraulic pressure increasing/decreasing machine and a number of stages used in the hydraulic pressure increasing/decreasing machine; and

FIG. 17 is a cross-sectional view of a boom cylinder including the assist cylinder.

### DETAILED DESCRIPTION

The above-mentioned high-pressure water supplying apparatus merely creates a water of a pressure higher than an air pressure, and is not capable of creating a water of a pressure lower than the air pressure. Thus, it is desirous to provide a fluid pressure increasing/decreasing machine capable of continuously supplying an output pressure including a pressure higher than an input pressure and a pressure lower than an input pressure, and a working machine equipped with such a fluid pressure increasing/decreasing machine.

A description will be given below, with reference to the drawings, of embodiments of the present invention.

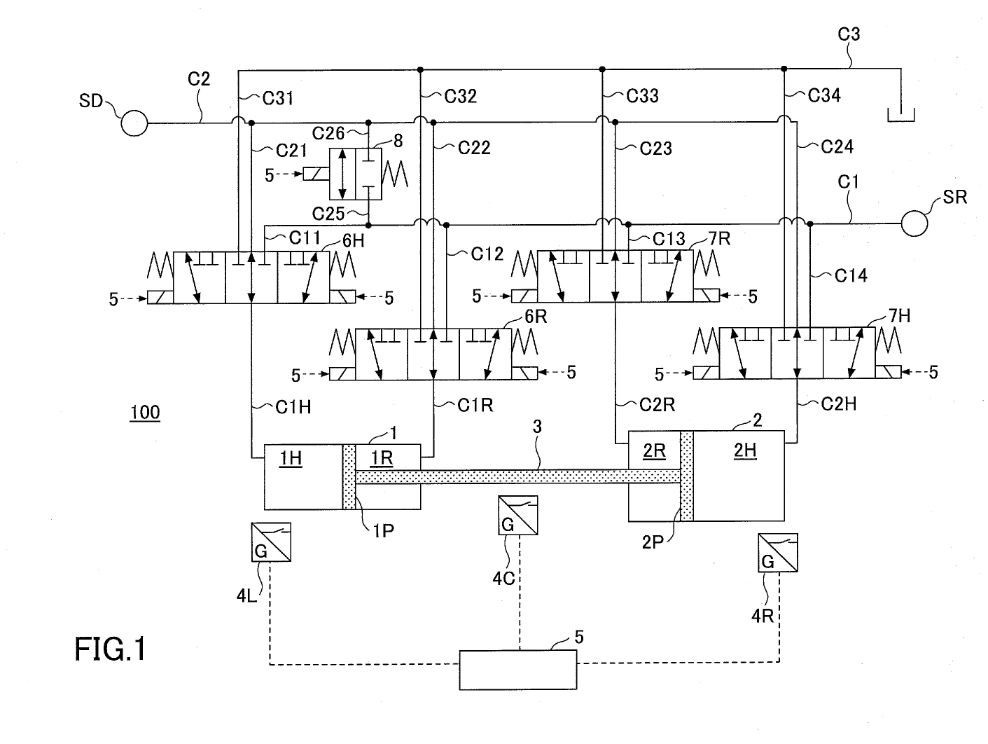

FIG. 1 is a hydraulic circuit diagram illustrating a hydraulic pressure increasing/decreasing machine 100 according to an embodiment of the present invention. The hydraulic pressure increasing/decreasing machine 100 mainly includes hydraulic cylinders 1 and 2, a piston rod 3, three proximity sensors 4C, 4L and 4R, a control device 5, flow control valves 6H, 6R, 7R and 7H, and an input/output direct-coupling switch valve 8. Hereinafter, a combination of the hydraulic cylinders 1 and 3 and the piston rod 3 is referred to as a hydraulic actuator.

The hydraulic cylinder 1 is an example of a fluid pressure cylinder, and includes a piston 1P having a cylindrical form that isolates a head-side pressure chamber 1H having a cylindrical form and a rod-side pressure chamber 1R having a cylindrical form from each other. Similarly, the hydraulic cylinder 2 is an example of a fluid pressure cylinder, and includes a piston 2P of having cylindrical form that isolates a head-side pressure chamber 2H having a cylindrical form and a rod-side pressure chamber 2R having a cylindrical form from each other. The piston 1P of the hydraulic cylinder 1 and the piston 2P of the hydraulic cylinder 2 are coupled to each other via the piston rod 3, and slide together in one piece in an interior of each of the hydraulic cylinder 1 and the hydraulic cylinder 2.

In the present embodiment, the cylinder inner diameter of the hydraulic cylinder 1 is smaller than the cylinder inner diameter of the hydraulic cylinder 2. The rod diameter of the piston rod 3 is uniform from a connecting part with the piston 1P to a connecting part with the piston 2P. Uniformizing the rod diameter of the piston rod 3 gives an effect of reducing a distance between the hydraulic cylinder 1 and the hydraulic cylinder 2. This is because portions of the piston rod 3 are caused to enter the hydraulic cylinder 1 and the hydraulic cylinder 2. It should be noted that the rod diameter of the piston rod 3 may be different between the connecting part with the piston 1P and the connecting part with the piston 2P. Differentiating the rod diameter gives an effect of enabling a more flexible setting of the pressure-receiving areas of the rod-side pressure chambers 1R and 2R.

The proximity sensor 4L is a sensor for detecting that a volume of the head-side pressure chamber 1H of the hydraulic cylinder 1 becomes an allowable minimum value. Specifically, the proximity sensor 4L, which is installed at an end portion of the hydraulic cylinder 1 on the side of the head-side pressure chamber 1H, detects that the piston 1P reaches the end of the hydraulic cylinder 1 by detecting that the piston 1P approaches within a predetermined distance range. The proximity sensor 4R is a sensor for detecting that a volume of the head-side pressure chamber 2H of the hydraulic cylinder 2 becomes an allowable minimum value. Specifically, the proximity sensor 4R, which is installed at an end portion of the hydraulic cylinder 2 on the side of the head-side pressure chamber 2H, detects that the piston 2P reaches the end of the hydraulic cylinder 2 by detecting that the piston 2P approaches within a predetermined distance range. The proximity sensor 4C is a sensor for detecting whether the piston 12 is placed at a position on the side of the head-side pressure chamber 1H viewing from a middle position of a stroke of the hydraulic cylinder 1 and the piston 2P is placed at a position on the side of the rod-side pressure chamber 2R viewing from a middle position of a stroke of the hydraulic cylinder 2 or the piston 1P is placed at a position on the side of the rod-side pressure chamber 1R viewing from the middle position of the stroke of the hydraulic cylinder 1 and the piston 2P is placed at a position on the side of the head-side pressure chamber 2H viewing from the middle position of the stroke of the hydraulic cylinder 2. Specifically, the proximity sensor 4C, which is installed between the hydraulic cylinder 1 and the hydraulic cylinder 2, detects as to on which side the piston 1P is present viewing from the middle position of the stroke of the hydraulic cylinder 1 and on which side the piston 2P is present viewing from the middle position of the stroke of the hydraulic cylinder 2 by detecting an approach of a member at a predetermined position of the piston rod 3 within a predetermined distance range.

It should be noted that the hydraulic pressure increasing/decreasing machine 100 may use a single potentiometer, which is capable of continuously measuring a position of the piston rod 3, instead of the three proximity sensors 4L, 4R and 4C.

The control device 5 is a device for controlling a motion of the hydraulic pressure increasing/decreasing machine 100, and is, for example, a computer including a CPU (Central Processing Unit), a RAM (Random Access Memory), a ROM (Read Only Memory), etc. Specifically, the control device 5 controls the flow control valves 6H, 6R, 7R and 7H and an operation of the input/output direct-coupling switch valve 8 in response to a desired output pressure. The desired output pressure is determined in response to a destination of supply of hydraulic oil, and, for example, determined in response to an input of an operator through an input device not illustrated. Additionally, the control device 5 controls operations of the flow control valves 6H, 6R, 7R and 7H based on outputs of the proximity sensors 4L, 4R and 4C. This is to enable to continuously supply a desired output pressure to a destination of supply while causing the pitons 1P and 2P and the piston rod 3 to move reciprocally.

The flow control valve 6H is a valve for controlling a flow of the hydraulic oil flowing into/out of the head-side pressure chamber 1H of the hydraulic cylinder 1. The flow control valve 6R is a valve for controlling a flow of the hydraulic oil flowing into/out of the rod-side pressure chamber 1R of the hydraulic cylinder 1. The flow control valve 7R is a valve for controlling a flow of the hydraulic oil flowing into/out of the rod-side pressure chamber 2R of the hydraulic cylinder 2. The flow control valve 7H is a valve for controlling a flow of the hydraulic oil flowing into/out of the head-side pressure chamber 2H of the hydraulic cylinder 2.

Specifically, the flow control valve 6H is connected to a source of supply SR of the hydraulic oil as an input through a pipe conduit C11 and a pipe conduit C1. The flow control valve 6H is connected to a destination of supply SD of the hydraulic oil as an output through a pipe conduit C21 and a pipe conduit C2. The flow control valve 6H is also connected to a hydraulic oil tank through a pipe conduit C31 and a pipe conduit C3. Additionally, the flow control valve 6H is connected to the head-side pressure chamber 1H of the hydraulic cylinder 1 through a pipe conduit C1H. The flow control valve 6R is connected to the source of supply SR through a pipe conduit C12 and the pipe conduit C1. The flow control valve 6R is connected to the destination of supply SD through a pipe conduit C22 and the pipe conduit C2. The flow control valve 6R is also connected to the hydraulic oil tank through a pipe conduit C32 and the pipe conduit C3. Additionally, the flow control valve 6R is connected to the rod-side pressure chamber 1R of the hydraulic cylinder 1 through a pipe conduit C1R. The flow control valve 7R is connected to the source of supply SR through a pipe conduit C13 and the pipe conduit C1. The flow control valve 7R is connected to the destination of supply SD through a pipe conduit C23 and the pipe conduit C2. The flow control valve 7R is also connected to the hydraulic oil tank through a pipe conduit C33 and the pipe conduit C3. Additionally, the flow control valve 7R is connected to the rod-side pressure chamber 2R of the hydraulic cylinder 2 through a pipe conduit C2R. The flow control valve 7H is connected to the source of supply SR through a pipe conduit C14 and the pipe conduit C1. The flow control valve 7H is connected to the destination of supply SD through a pipe conduit C24 and the pipe conduit C2. The flow control valve 7H is also connected to the hydraulic oil tank through a pipe conduit C34 and the pipe conduit C3. Additionally, the flow control valve 7H is connected to the head-side pressure chamber 2H of the hydraulic cylinder 2 through a pipe conduit C2H.

The input/output direct-coupling switch valve 8 is a valve for switching whether to directly coupling an input and an output of the hydraulic pressure increasing/decreasing machine 100.

Specifically, the input/output direct-coupling switch valve 8 is connected to the source of supply SD through a pipe conduit C25 and the pipe conduit C1, and connected to the destination of supply SD through a pipe conduit C26 and the pipe conduit C2. It should be noted that the hydraulic pressure increasing/decreasing machine 100 may omit the input/output direct-coupling switch valve 8.

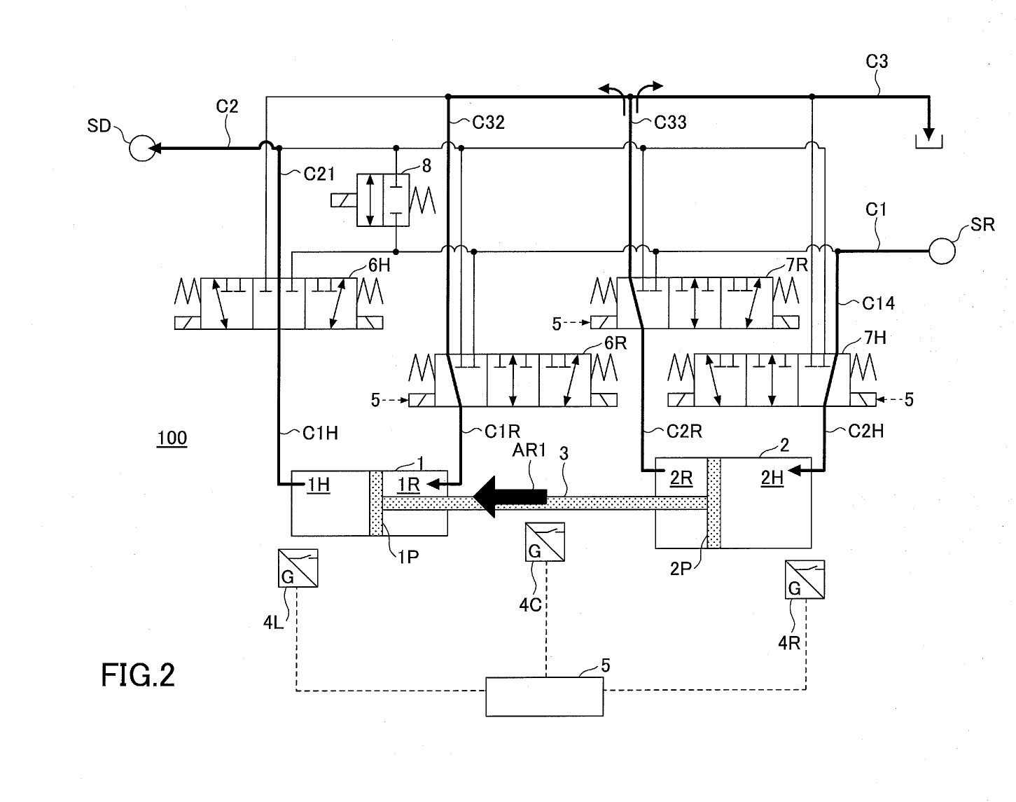

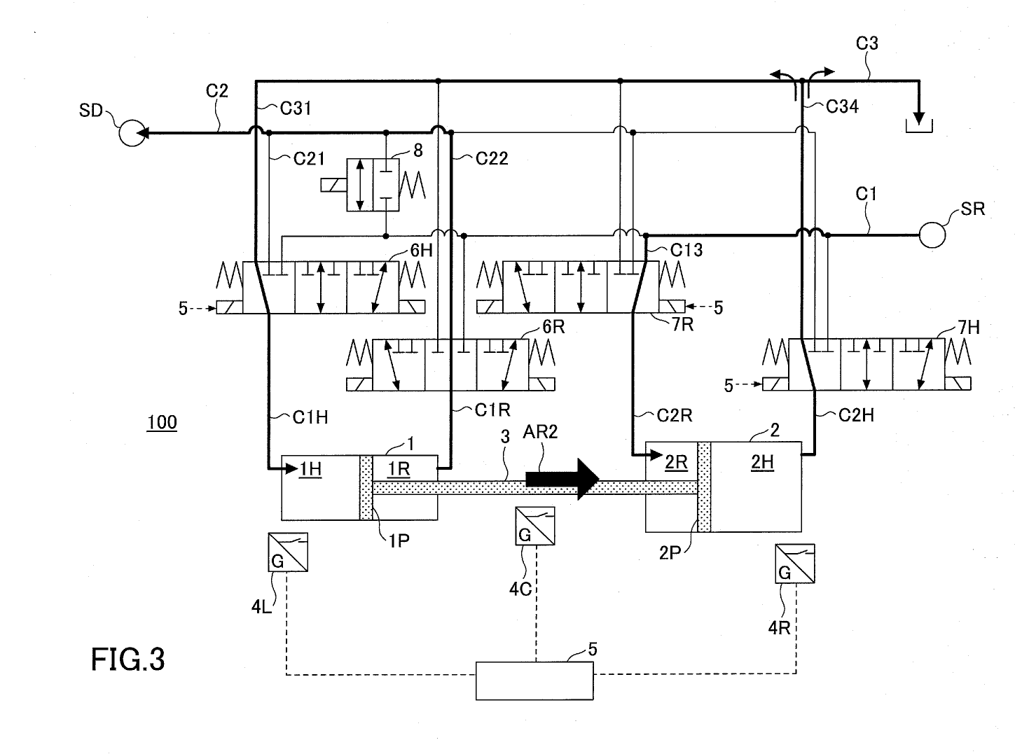

Next, a description will be given, with reference to FIG. 2 and FIG. 3, of an operation of the hydraulic pressure increasing/decreasing machine 100. It should be noted that FIG. 2 is a diagram illustrating a state where an output pressure higher than an input pressure is supplied to the source of supply SD at a predetermined pressure-increasing ratio while moving the piston rod 3 in a direction indicated by an arrow AR1. Additionally, FIG. 3 is a diagram illustrating a state where an output pressure higher than an input pressure is supplied to the source of supply SD at the predetermined pressure-increasing ratio the same as the case of FIG. 2 while moving the piston rod 3 in a direction indicated by an arrow AR2.

In FIG. 2, the control device 5 of the hydraulic pressure increasing/decreasing machine 100 transmits a control signal to the flow control valve 6R to cause a pipe conduit C1R and the pipe conduit C32 to communicate with each other. Additionally, the control device 5 transmits a control signal to the flow control valve 7R to cause the pipe conduit C2R and the pipe conduit C33 to communicate with each other. Additionally, the control device 5 transmits a control signal to the flow control valve 7H to cause the pipe conduit C2H and the pipe conduit C14 to communicate with each other. It should be noted that the control device 5 does not transmit a control signal to the flow control valve 6H to cause the pipe conduit C1H and the pipe conduit C21 to communicate with each other.

As a result, as indicated by black bold lines in FIG. 2, the hydraulic oil from the source of supply SR flows into the head-side pressure chamber 2H by flowing through the pipe conduits C1, C14 and C2H, and pushes the piston 2P in a direction indicated by an arrow AR1 with a predetermined input pressure. Then, the hydraulic oil in the head-side pressure chamber 1H generates an output pressure higher than the input pressure at a predetermined pressure-increasing ratio, and reaches the destination of supply SD by flowing through the pipe conduits C1H, C21 and C2. In this case, the head-side pressure chamber 2H serves as an input pressure chamber and the head-side pressure chamber 1H serves as an output pressure chamber.

It should be noted that the predetermined pressure-increasing ratio corresponds to a ratio of a pressure-receiving area of the piston 1P to a pressure-receiving area of the piston 2P. In this case, the pressure-receiving area of the piston 2P corresponds to an area of the circular surface of the piston 2P, and the pressure-receiving area of the piston 1P corresponds to an area of the circular surface of the piston 1P.

Moreover, a part of the hydraulic oil in the rod-side pressure chamber 2R flows through the pipe conduits C2R, C33, C32 and C1R, and flows into the rod-side pressure chamber 1R. This is to compensate for a lack of hydraulic oil generated by an increase in the volume of the rod-side pressure chamber 2R due to the movement of the piston 1P in the direction of the arrow AR1. It should be noted that the rest of the hydraulic oil in the rod-side pressure chamber 2R flows through the pipe conduits C2R, C33 and C3 and ejected into the hydraulic oil tank. In this case, the hydraulic oil in each of the rod-side pressure chamber 1R and the rod-side pressure chamber 2R does not give influence to the output pressure.

Thereafter, when the proximity sensor 4L detects that the piston 1P reaches the end part of the hydraulic cylinder 1 on the side of the head-side pressure chamber 1H, the control device 5 switches the state of the flow control valves 6H, 6R, 7R and 7H to the state illustrated in FIG. 3 so that the supply of the desired output pressure is continued.

In FIG. 3, the control device 5 of the hydraulic pressure increasing/decreasing machine 100 transmits a control signal to the flow control valve 6H to cause the pipe conduit C1H and the pipe conduit C31 to communicate with each other. Additionally, the control device 5 stops transmitting the control signal to the flow control valve 6R to cause the pipe conduit C1R and the pipe conduit to communicated with each other. Additionally, the control device 5 transmits a control signal to the flow control valve 7R to cause the pipe conduit C2R and the pipe conduit C13 to communicate with each other. Additionally, the control device 5 transmits a control signal to the flow control valve 7H to cause the pipe conduit C2H and the pipe conduit C34 to communicate with each other.

As a result, as indicated by black bold lines in FIG. 3, the hydraulic oil from the source of supply SR flows into the rod-side pressure chamber 2R by flowing through the pipe conduits C1, C13 and C2R, and pushes the piston 2P in a direction indicated by an arrow AR2 with the same input pressure as that of the case of FIG. 2. Then, the hydraulic oil in the head-side pressure chamber 1R generates an output pressure higher than the input pressure at a predetermined pressure-increasing ratio substantially equal to that of the case of FIG. 2, and reaches the destination of supply SD by flowing through the pipe conduits C1R, C22 and C2. In this case, the rod-side pressure chamber 2R serves as an input pressure chamber and the rod-side pressure chamber 1R serves as an output pressure chamber.

It should be noted that the predetermined pressure-increasing ratio corresponds to a ratio of the pressure-receiving area of the piston 1P to the pressure-receiving area of the piston 2P. In this case, the pressure-receiving area of the piston 2P corresponds to an area (area of an annular part) acquired by subtracting the circular cross-sectional area of the piston rod 3 from the area of the circular surface of the piston 2P. The pressure-receiving area of the piston 1P corresponds to an area (area of an annular part) acquired by subtracting the circular cross-sectional area of the piston rod 3 from the area of the circular surface of the piston 1P. Thereby, the pressure-increasing ratio substantially equal to the case of FIG. 2 is realized.

Moreover, a part of the hydraulic oil in the head-side pressure chamber 2H flows through the pipe conduits C2H, C34, C3 and C1H, and flows into the head-side pressure chamber 1H. This is to compensate for a lack of hydraulic oil generated by an increase in the volume of the head-side pressure chamber 1H due to the movement of the piston 1P in the direction of the arrow AR2. It should be noted that the rest of the hydraulic oil in the head-side pressure chamber 2H flows through the pipe conduits C2H, C34 and C3 and ejected into the hydraulic oil tank. In this case, the hydraulic oil in each of the head-side pressure chamber 1H and the head-side pressure chamber 2H does not give influence to the output pressure.

Thereafter, when the proximity sensor 4R detects that the piston 2P reaches the end part of the hydraulic cylinder 1 on the side of the head-side pressure chamber 2H, the control device 5 switches the state of the flow control valves 6H, 6R, 7R and 7H to the state illustrated in FIG. 2 so that the supply of the desired output pressure is continued.

As mentioned above, the hydraulic pressure increasing/decreasing machine 100 is capable of continuously supplying an output pressure higher than an input pressure at a desired pressure-increasing ratio while alternately repeating the state illustrated in FIG. 2 and the state illustrated in FIG. 3

Additionally, the hydraulic pressure increasing/decreasing machine 100, when moving the piston rod 3 in the direction indicated by the arrow AR1, causes the head-side pressure chamber 2H to serve as an input pressure chamber and the head-side pressure chamber 1H to serve as an output chamber. Then, the hydraulic pressure increasing/decreasing machine 100, when moving the piston rod 3 in the direction indicated by the arrow AR2, the rod-side pressure chamber 2R is caused to serve as an input pressure chamber and the rod-side pressure chamber 1R is cause to serve as an output chamber. As a result, the hydraulic pressure increasing/decreasing machine 100 is configured to be capable of continuously supplying an output pressure higher than an input pressure at a substantially equal pressure-increasing ratio even in a case where the piston rod 3 moves in either direction. However, the hydraulic pressure increasing/decreasing machine 100 may be capable of continuously supplying an output pressure different from an input pressure at a predetermined pressure conversion ratio including a ratio that causes a depressurization while selecting one or more of other pressure chambers as an input pressure chamber and an output pressure chamber.

It should be noted that, when starting to move the pistons 1P and 2P, the control device 5 causes the pistons 1P and 2P to move first in a direction by which a large piston stroke can be taken in consideration of information regarding present positions of the pistons 1P and 2P.

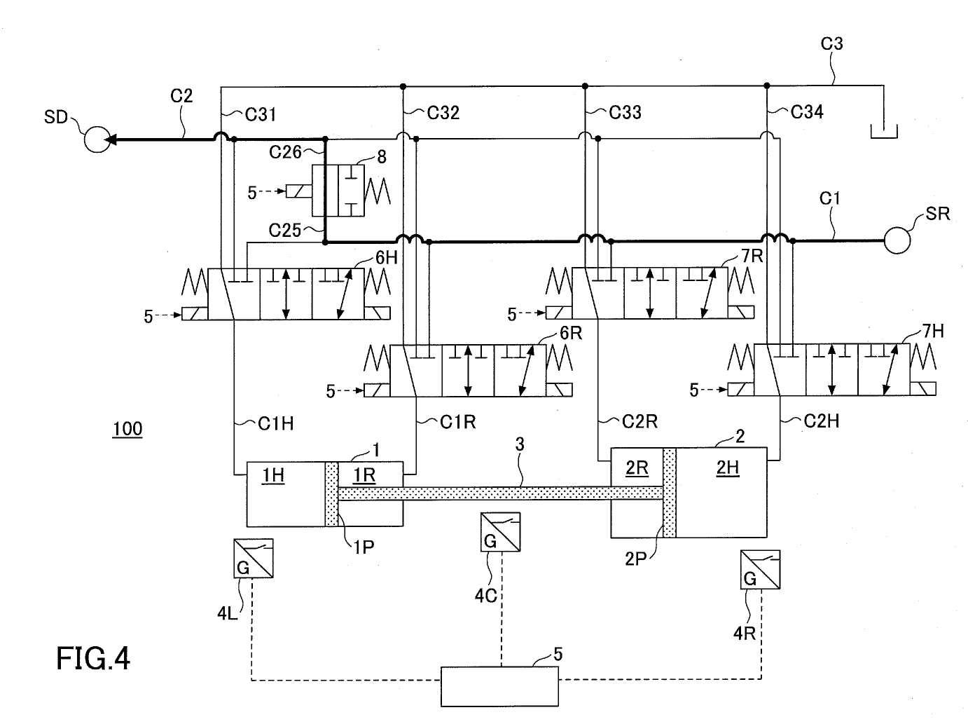

Next, a description is given, with reference to FIG. 4, of an operation of the input/output direct-coupling switch valve 8. FIG. 4 is a diagram illustrating a state of supplying to the destination of supply SD the input pressure of the source of supply SR as an output pressure without change while not moving the piston rod 3.

In FIG. 4, the control device 5 transmits a control signal to the flow control valve 6H to cause the pipe conduit C1H and the pipe conduit C31 to communicate with each other. Additionally, the control device 5 transmits a control signal to the flow control valve 7R to cause the pipe conduit C1R and the pipe conduit C32 to communicate with each other. Additionally, the control device 5 transmits a control signal to the flow control valve 7H to cause the pipe conduit C2H and the pipe conduit C34 to communicate with each other. Those controls are to prevent the hydraulic oil from the source of supply SR or the destination of supply SD from flowing into the head-side pressure chambers 1H and 2H and the rod-side pressure chambers 1R and 2R.

Moreover, the control device 5 transmits a control signal to the input/output direct-coupling switch valve 8 to cause the pipe conduit C1 and the pipe conduit C2 to communicate with each other by causing the pipe conduit C25 and the pipe conduit C26 to communicate with each other.

As mentioned above, the hydraulic pressure increasing/decreasing machine 100 is capable of supplying an input pressure of the source of supply SR to the destination of supply SD without change.

Although the output pressure (pressure in the pipe conduit C2) is changed in response to the change in the input pressure (pressure in the pipe conduit C1) by causing the hydraulic oil flowing from the source of supply SR to the destination of supply SD in the above-mentioned embodiment, the input pressure (pressure in the pipe conduit C1) may be changed in response to the change in the output pressure (pressure in the pipe conduit C2) by causing the hydraulic oil flowing from the destination of supply SD to the source of supply SR.

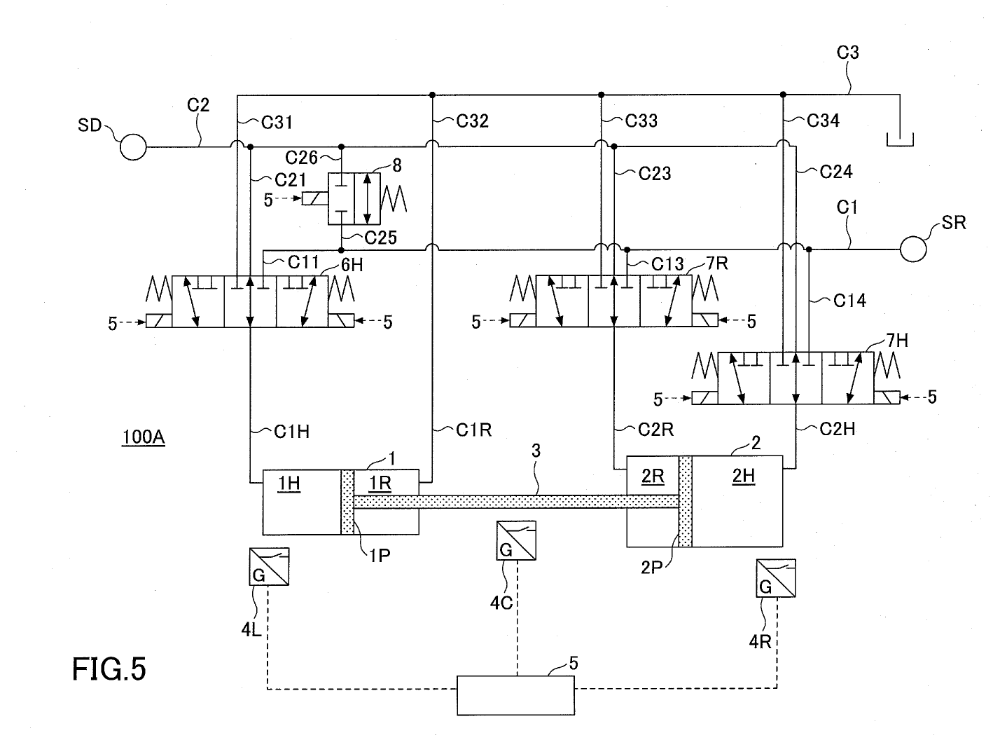

Next, a description is given, with reference to FIG. 5, of a hydraulic pressure increasing/decreasing machine 100A having a different structure from the hydraulic pressure increasing/decreasing machine 100. It should be noted that FIG. 5, which corresponds to FIG. 1, is a hydraulic circuit diagram illustrating a structure of the hydraulic pressure increasing/decreasing machine 100A.

The hydraulic pressure increasing/decreasing machine 100A differs from the hydraulic pressure increasing/decreasing machine 100 of FIG. 1 in a point that the flow control valve 6R is omitted and the rod-side pressure chamber 1R is directly connected to the hydraulic oil tank, but other parts are the same as that of the hydraulic pressure increasing/decreasing machine 100. Thus, a description is given of the different part in detail while omitting descriptions of the same parts.

As illustrated in FIG. 5, the rod-side pressure chamber 1R of the hydraulic cylinder 1 is always connected to the hydraulic oil tank through the pipe conduits C1R, C32 and C3. Thus, the hydraulic oil from the source of supply SR does not flow into the rod-side pressure chamber 1R, and also the hydraulic oil in the rod-side pressure chamber 1R does not reach the source of supply SD.

According to this structure, the hydraulic pressure increasing/decreasing machine 100A cannot select the rod-side pressure chamber 1R as an input pressure chamber or an output pressure chamber, thereby reducing a number of pressure conversion ratios that are achievable as compared to the hydraulic pressure increasing/decreasing machine 100. However, in a case of using a limited number of pressure conversion ratios, the hydraulic pressure increasing/decreasing machine 100A can realize substantially the same operation as the hydraulic pressure increasing/decreasing machine 100 by a structure simpler than that of the hydraulic pressure increasing/decreasing machine 100.

Although a structure of always connecting the rod-side pressure chamber 1R to the hydraulic oil tank is used in FIG. 5, a structure of always connecting any one of the head-side pressure chambers 1H and 2H and the rod-side pressure chamber 2R instead of the rod-side pressure chamber 1R may be used.

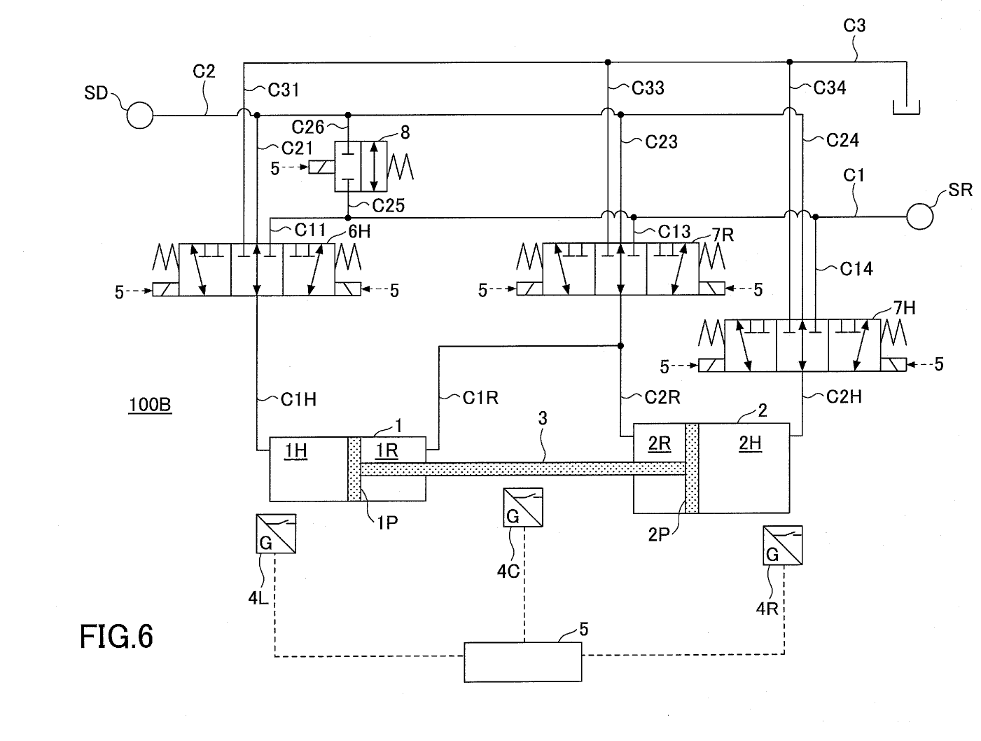

Next, a description is given, with reference to FIG. 6, of a hydraulic pressure increasing/decreasing machine 100B having a further different structure from the hydraulic pressure increasing/decreasing machine 100. FIG. 6, which corresponds to FIG. 1, is a hydraulic circuit diagram illustrating a structure of the hydraulic pressure increasing/decreasing machine 100B.

The hydraulic pressure increasing/decreasing machine 100B differs from the hydraulic pressure increasing/decreasing machine 100 of FIG. 1 in a point that the flow control valve 6R is omitted and the rod-side pressure chamber 1R is directly connected to the pipe conduit C2R, but other parts are the same as that of the hydraulic pressure increasing/decreasing machine 100. Thus, a description is given of the different part in detail while omitting descriptions of the same parts.

As illustrated in FIG. 6, the rod-side pressure chamber 1R of the hydraulic cylinder 1 is always connected to the rod-side pressure chamber 2R through the pipe conduits C1R and C2R. Thus, the hydraulic oil from the source of supply SR does not flow into only the rod-side pressure chamber 1R. When the hydraulic oil from the source of supply SR flows into the rod-side pressure chamber 1R, the hydraulic oil from the source of supply SR always flows into also the rod-side pressure chamber 2R. Additionally, the entire hydraulic oil in the rod-side pressure chamber 1R does not reach the source of supply SR. When the hydraulic oil in the rod-side pressure chamber 1R reaches the destination of supply SD, the hydraulic oil from the rod-side pressure chamber 1R always flows into also the rod-side pressure chamber 2R.

According to this structure, the hydraulic pressure increasing/decreasing machine 100B cannot select the rod-side pressure chamber 1R as an input pressure chamber or an output pressure chamber, thereby reducing a number of pressure conversion ratios that are achievable as compared to the hydraulic pressure increasing/decreasing machine 100. However, in a case of using a limited number of pressure conversion ratios, the hydraulic pressure increasing/decreasing machine 100B can realize substantially the same operation as the hydraulic pressure increasing/decreasing machine 100 with a structure simpler than that of the hydraulic pressure increasing/decreasing machine 100.

Although a structure of always connecting the rod-side pressure chamber 1R to the rod-side pressure chamber 2R is used in FIG. 6, instead, a structure of always connecting the rod-side pressure chamber 1R to one or a plurality of other pressure chambers may be used. Additionally, instead of always connecting the rod-side pressure chamber 1R to the rod-side pressure chamber 2R, a structure of always connecting any one of the head-side pressure chambers 1H and 2H and the rod-side pressure chamber 2R to one or a plurality of other pressure chambers may be used.

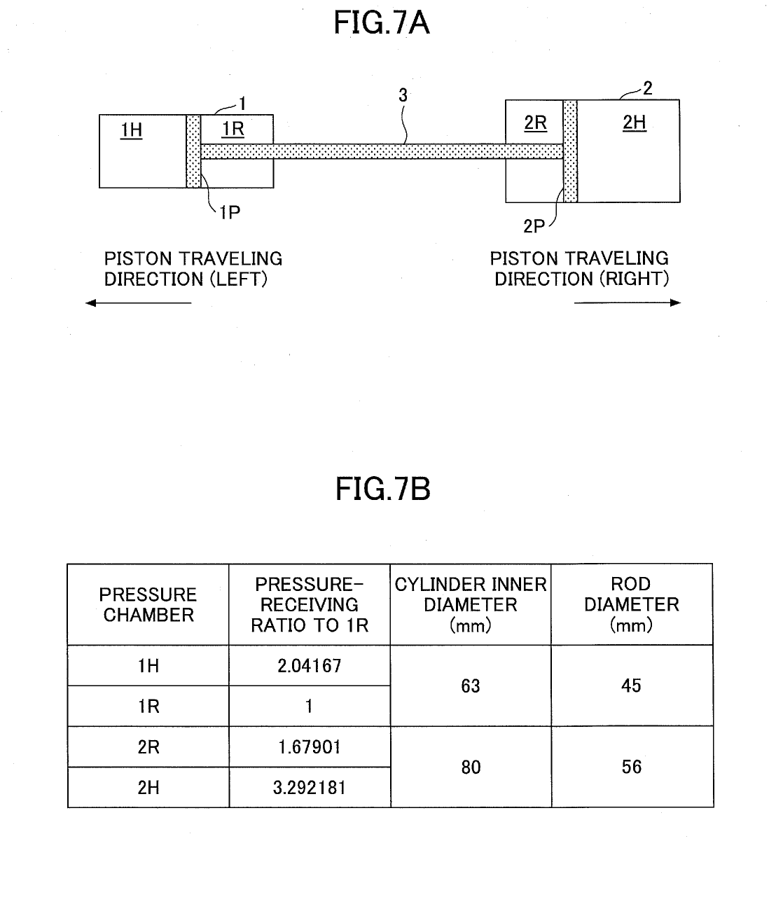

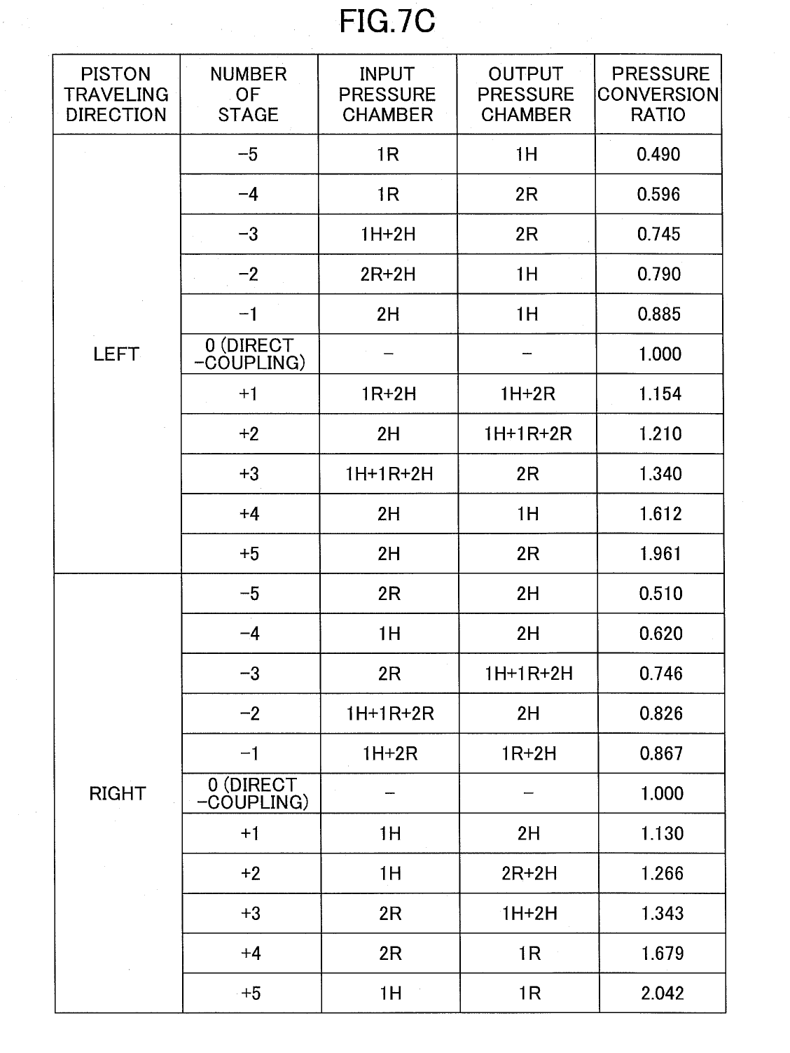

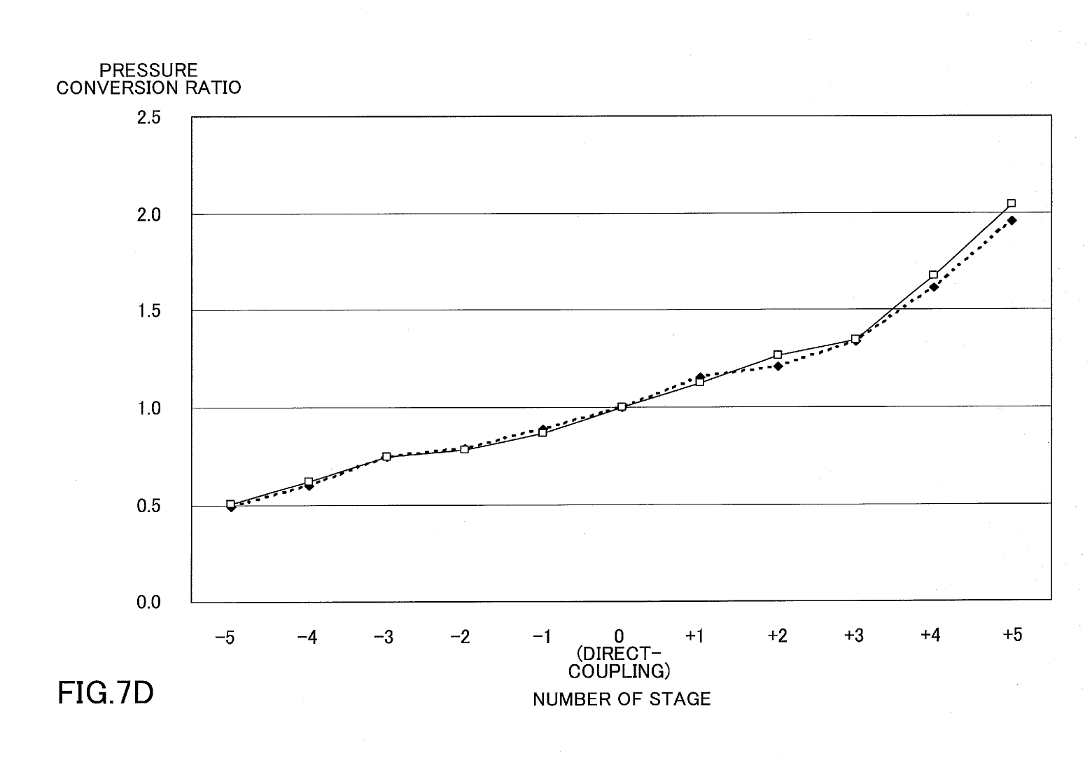

Next, a description will be given, with reference to FIGS. 7A through 7D, of a pressure conversion ratio achievable by the hydraulic pressure increasing/decreasing ratio. FIG. 7A is an enlarged view of the hydraulic cylinders 1 and 2 and the piston rod 3 of the hydraulic pressure increasing/decreasing machine 100 illustrated in FIG. 1. FIG. 7B is a specification table illustrating details of the hydraulic cylinders 1 and 2. FIG. 7C is a table illustrating details of pressure conversion ratios achievable by the hydraulic pressure increasing/decreasing machine 100. FIG. 7D is a graph indicating a relationship between the pressure conversion ratios of FIG. 7C and a number of stages thereof.

As illustrated in FIG. 7B, the pressure-receiving area of the head-side pressure chamber 1H is about 2.0 times the pressure-receiving area of the rod-side pressure chamber 1R. The pressure-receiving area of the rod-side pressure chamber 2R is about 1.7 times the pressure-receiving area of the head-side pressure chamber 1R, and the pressure-receiving area of the head-side pressure chamber 2H is about 3.3 times the pressure-receiving area of the rod-side pressure chamber 1R. The pressure-receiving area of the rod-side pressure chamber 1R is an area (area of an annular part) acquired by subtracting the cross-sectional area of the piston rod 3 from the surface area of the head-side pressure chamber 1H. Similarly, the pressure-receiving area of the rod-side pressure chamber 2R is an area (area of an annular part) acquired by subtracting the cross-sectional area of the piston rod 3 from the surface area of the head-side pressure chamber 2H.

Under this condition, as illustrated in FIG. 7C, the hydraulic pressure increasing/decreasing machine 100 is configured to be capable of setting pressure conversion ratios of a total of 11 stages from −5 stage to +5 stage containing the 0 stage when moving the pistons 1 and 2 in the leftward direction. Similarly, the hydraulic pressure increasing/decreasing machine 100 is configured to be capable of setting pressure conversion ratios of a total of 11 stages from −5 stage to +5 stage containing 0 stage when moving the pistons 1 and 2 also in the rightward direction. It should be noted that the stage indicated by a positive value represents a stage for increasing pressure. The stage indicated by a negative value represents a number of stages for decreasing pressure. The 0 stage represents a stage when the input and output are directly coupled. Accordingly, FIG. 7C illustrates that the hydraulic pressure increasing/decreasing machine 100 has 5 stages for increasing pressure, 5 stages for decreasing pressure and 1 stage for directly coupling the input and output.

Moreover, FIG. 7C indicates, for example, that the pressure conversion ratio (0.490) of −5 stage in a case where the piston traveling direction is leftward is achieved when the rod-side pressure chamber 1R is selected for an input pressure chamber and the head-side pressure chamber 1H is selected for an output pressure chamber. Additionally, FIG. 7C indicates, for example, that the pressure conversion ratio (0.510) of −5 stage in a case where the piston traveling direction is rightward is achieved when the rod-side pressure chamber 2R is selected for an input pressure chamber and the head-side pressure chamber 2H is selected for an output pressure chamber.

Moreover, FIG. 7C indicates a characteristic that the pressure conversion ratios of each of the corresponding stages in the piston traveling directions of leftward and rightward are substantially equal. For example, the pressure conversion ratio (0.745) of −3 stage in the case where the piston traveling direction is leftward is substantially equal to the pressure conversion ratio (0.746) of −3 stage in the case where the piston traveling direction is rightward. This characteristic is necessary for acquiring that a desired output pressure is continuously supplied even when the piston traveling direction is switched between leftward and rightward.

FIG. 7D is an illustration of indicating, in easily understandable manner, the characteristic that the pressure conversion ratios of corresponding states in the leftward and rightward piston traveling directions are substantially equal. A solid line in the graph of FIG. 7D indicates a transition of a pressure conversion ratio when the piston traveling direction is rightward, and a dotted line indicates a transition of a pressure conversion ratio when the piston traveling direction is leftward. As illustrated in FIG. 7D, the pressure conversion ratios of the corresponding stages in the leftward and rightward piston traveling directions are set to increase as the stage goes up while the rations are maintained to be substantially equal.

Moreover, although an odd number of stages, that is, 11 stages, are set in FIGS. 7A and 7B, an even number of stages may be set. In such a case, an even number of stages may be achieved by omitting 0 stage, which is a stage when the input and output are directly coupled.

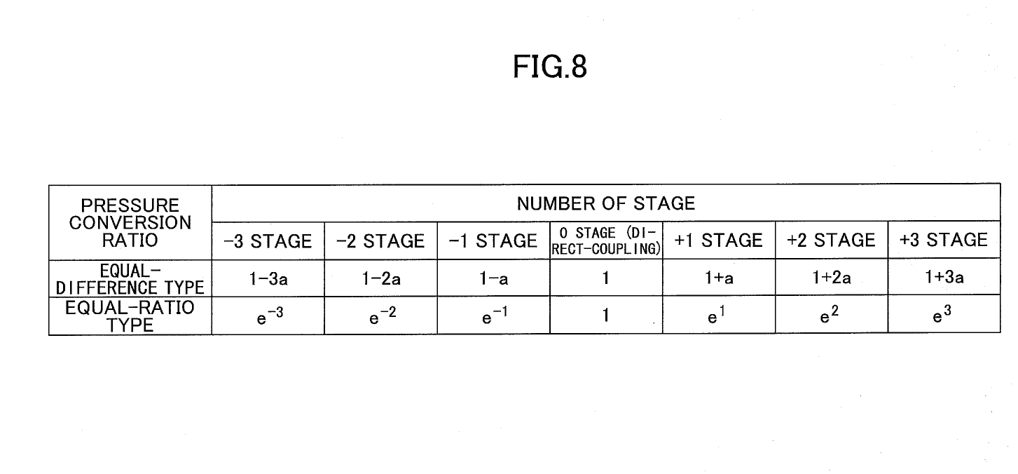

Next, a description will be given, with reference to FIG. 8, of a desired distribution of the pressure conversion ratios. FIG. 8 is an illustration for explaining a desired distribution of the pressure conversion ratios in the hydraulic pressure increasing/decreasing machine 100 having three stages for pressure-increasing, three stages for pressure-decreasing and one stage for directly coupling an input and an output. Additionally, FIG. 8 illustrates that there are an equal-difference type and an equal-ratio type as a desired distribution of the pressure conversion ratios. It should be noted that a distribution of the pressure conversion ratio is set so that distributions in the leftward and rightward piston traveling directions are substantially equal to each other.

The equal-difference type means a method of distributing the pressure conversion ratios so that differences between the pressure conversion ratios of adjacent two stages are substantially equal to each other, and a line of the pressure conversion ratios forms an arithmetic progression. It should be noted that “a” in the figure corresponds to a common difference.

The equal-ratio type means a method of distributing the pressure conversion ratios so that ratios of the pressure conversion ratios of adjacent two stages are substantially equal to each other, and a line of the pressure conversion ratios forms a geometric progression. It should be noted that “e” in the figure corresponds to a common ratio.

Even if either one of the equal-difference type and the equal-ratio type is selected, a designer first determines a maximum pressure conversion ratio and a minimum pressure conversion ratio. Then, the designer determines a number of stages to be set between the maximum pressure conversion ratio and the minimum pressure conversion ratio. Thereafter, the designer determines a distribution of the pressure conversion ratios in the hydraulic pressure increasing/decreasing machine 100.

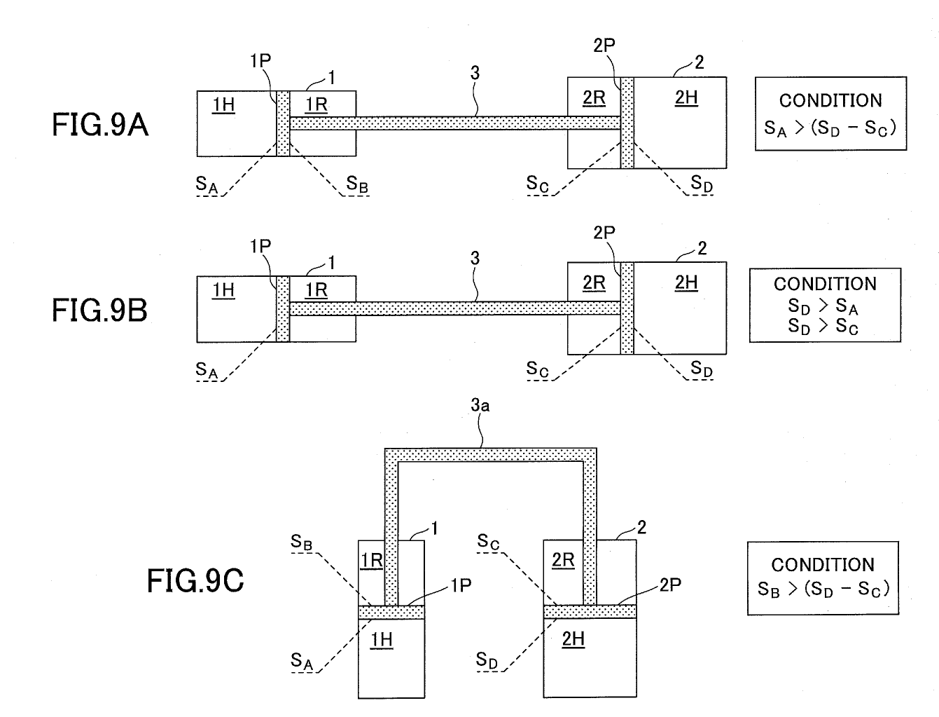

Next, a description will be given, with reference to FIGS. 9A through 9C, of a relationship between the pressure-receiving areas of the pressure chambers necessary for achieving a line of the pressure conversion ratios.

FIG. 9A illustrates a relationship between the pressure-receiving areas of the pressure chambers in the case (hereinafter, referred to as “four-chamber type”) where there are four pressure chambers usable as an input pressure chamber or an output pressure chamber as explained with reference to FIG. 1.

According to the four-chamber type, the pressure-receiving areas of the pressure chambers are determined so that the head-side pressure-receiving area of one of two hydraulic cylinders having a smaller head-side pressure receiving area is larger than a difference between the head-side pressure-receiving area and the rod-side pressure-receiving area of the other of the hydraulic cylinders.

Specifically, the cylinder inner diameters of the hydraulic cylinders 1 and 2 and the rod diameter of the piston rod 3 are determined so that the head-side pressure-receiving area S_{A} of the hydraulic cylinder 1 having the smaller head-side pressure-receiving area becomes larger than a difference between the head-side pressure-receiving area S_{D} and the rod-side pressure-receiving area S_{C} of the hydraulic cylinder 2, that is, a relationship S_{A}>(S_{D}−S_{C}) is satisfied.

FIG. 9B illustrates a relationship between the pressure-receiving areas of the pressure chambers in the case (hereinafter, referred to as “three-chamber type”) where there are three pressure chambers usable as an input pressure chamber or an output pressure chamber as explained with reference to FIG. 5.

According to the three-chamber type, the pressure-receiving area Sα, the pressure-receiving area Sγ and the pressure-receiving are Sδ satisfy a relationship Sδ>Sα and Sδ>Sγ there are two pressure chambers serving as an input pressure chamber when moving the piston in one direction, and one pressure chamber serving as an input pressure chamber when moving the piston in an opposite direction.

Specifically, in FIG. 9B, the cylinder inner diameters of the hydraulic cylinders 1 and 2 and the rod-diameter of the piston rod 3 are determined so that either one of the pressure-receiving area S_{A} (corresponding to the pressure-receiving area Sα) of the head-side pressure chamber 1H (corresponding to the pressure chamber α) of the hydraulic cylinder 1 and the pressure-receiving area S_{C} (corresponding to the pressure-receiving area Sγ) of the rod-side pressure chamber 2R (corresponding to the pressure chamber γ) of the hydraulic cylinder 2, which serves as an input pressure chamber when moving the pistons 1P and 2P in the rightward direction, becomes smaller than the head-side pressure-receiving area (corresponding to the pressure-receiving area Sδ) of the head-side pressure chamber 2H (corresponding to the pressure chamber δ) of the hydraulic cylinder 2, which serves as an output pressure chamber, that is, a relationship S_{D}>S_{A} and S_{D}>S_{C} is satisfied.

FIG. 9C illustrates a relationship between the pressure-receiving areas of the pressure chambers in the case (hereinafter, referred to as “two-cylinder translation type”) where two rod-side pressure chambers are arranged in parallel instead of arranging the rod-side pressure chambers of the two hydraulic cylinders opposite to each other as is in FIG. 9A. The piston 1P and the piston 2P are coupled via the piston rod 3a so that the pistons 1P and 2P move in upward and downward directions of the figure together in one piece within the interiors of the respective hydraulic cylinders 1 and 2.

According to the two-cylinder translation type, the pressure-receiving areas of the pressure chambers are determined so that the rod-side pressure-receiving area of one of the two hydraulic cylinders having a smaller head-side pressure-receiving area becomes larger than a difference between the head-side pressure-receiving area and the rod-side pressure-receiving area of the other of the two hydraulic cylinders.

Specifically, the cylinder inner diameters of the hydraulic cylinders 1 and 2 and the rod diameter of the piston rod 3 are determined so that the rod-side pressure-receiving area S_{B} of the hydraulic cylinder 1 having the smaller head-side pressure receiving area becomes larger than a difference between the head-side pressure-receiving area S_{D} and the rod-side pressure-receiving area S_{C} of the hydraulic cylinder 2, that is, a relationship S_{B}>(S_{D}−S_{C}) is satisfied.

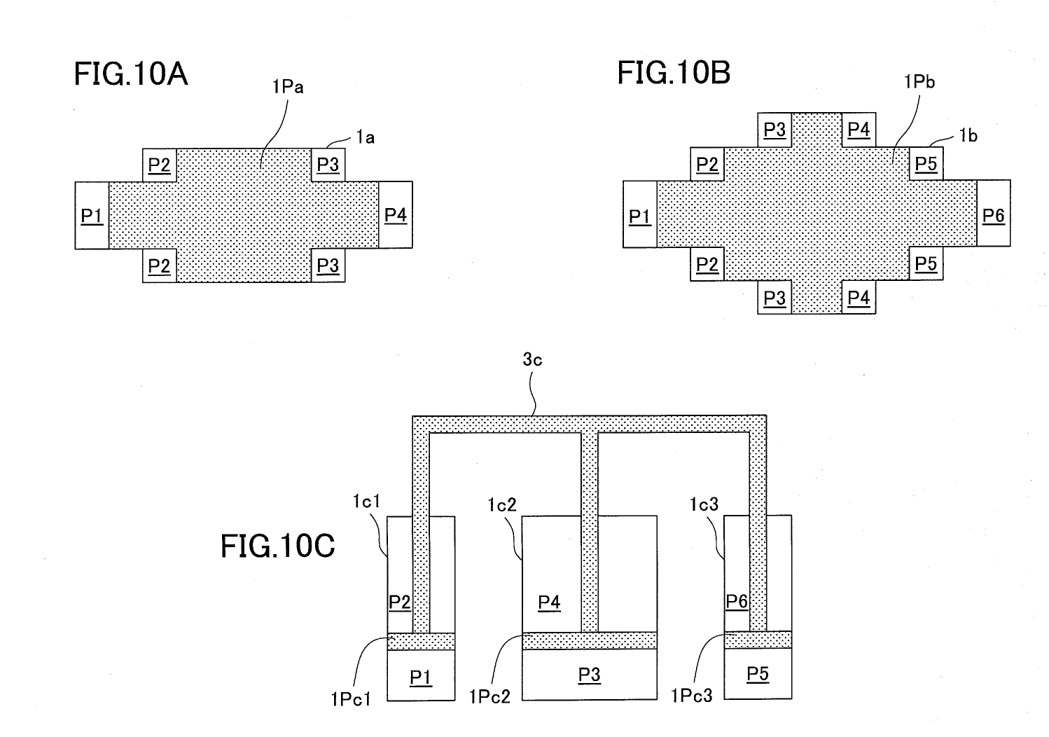

Next, a description will be given, with reference to FIGS. 10A through 100, of other structures of the hydraulic actuator. FIGS. 10A through 100 are cross-sectional views illustrating other structures of the hydraulic actuator.

FIG. 10A illustrates a structure of a hydraulic cylinder 1a usable instead of the combination of the hydraulic cylinders 1 and 2 and the piston rod 3, which is the hydraulic actuator in each of the hydraulic pressure increasing/decreasing machines 100, 100A and 100B.

The hydraulic cylinder 1a is an example of a fluid pressure cylinder, and has a three-stage cylindrical external form. The hydraulic cylinder 1a accommodates a piston 1Pa having a three-stage cylindrical form therein slidably in the leftward and rightward directions in the figure. Four pressure chambers P1 to P4 are formed between the inner wall of the hydraulic cylinder 1a and the piston 1Pa. Each of the four pressure chambers P1 to P4 is selectively communicated with one of the source of supply SR, the destination of supply SD and the hydraulic oil tank via a flow control valve.

Similarly, FIG. 10B illustrates a structure of a hydraulic cylinder 1b usable instead of the combination of the hydraulic cylinders 1 and 2 and the piston rod 3, which is the hydraulic actuator in each of the hydraulic pressure increasing/decreasing machines 100, 100A and 100B.

The hydraulic cylinder 1b is an example of a fluid-pressure cylinder, and has a five-stage cylindrical external form. The hydraulic cylinder 1b accommodates a piston 1Pb having a five-stage cylindrical form therein slidably in the leftward and rightward directions in the figure. Six pressure chambers P1 to P6 are formed between the inner wall of the hydraulic cylinder 1b and the piston 1Pb. Each of the six pressure chambers P1 to P6 is selectively communicated with one of the source of supply SR, the destination of supply SD and the hydraulic oil tank via a flow control valve. It is preferable to provide six flow control valves to correspond to the six pressure chambers P1 to P6.

Similarly, FIG. 100 illustrates a structure of a hydraulic cylinder usable instead of the hydraulic actuator in each of the hydraulic pressure increasing/decreasing machines 100, 100A and 100B.

The hydraulic actuator of FIG. 100 is configured by three hydraulic cylinders 1c1, 1c2 and 1c3, and a piston rod 3c.

The hydraulic cylinder 1c1 is an example of a fluid pressure cylinder, and has a cylindrical piston 1Pc1 for separating a cylindrical head-side pressure chamber P1 and the cylindrical rod-side pressure chamber P2 from each other. The hydraulic cylinder 1c2 is an example of a fluid pressure cylinder, and has a cylindrical piston 1Pc2 for separating a cylindrical head-side pressure chamber P3 and the cylindrical rod-side pressure chamber P4 from each other. The hydraulic cylinder 1c3 is an example of a fluid pressure cylinder, and has a cylindrical piston 1Pc3 for separating a cylindrical head-side pressure chamber P5 and the cylindrical rod-side pressure chamber P6 from each other.

The pistons 1Pc1, 1Pc2 and 1Pc3 are coupled via the piston rod 3c, and slide together in one piece within the respective hydraulic cylinders 1c1, 1c2 and 1c3. Each of the six pressure chambers P1 to P6 is selectively communicated with one of the source of supply SR, the destination of supply SD and the hydraulic oil tank via a flow control valve. It should be noted that it is preferable to provide six flow control valves to correspond to the six pressure chambers P1 through P6. Additionally, the pressure chambers P1 and P5 may be controlled by a common flow control valve, and the pressure chambers P2 and P6 may be controlled by a common flow control valve. In this case, the configuration is substantially equivalent to the hydraulic pressure increasing/decreasing machine illustrated in FIG. 9C.

According to the above-mentioned configuration, the hydraulic pressure increasing/decreasing machines 100, 100A and 100B switchably selects an input pressure chamber and an output pressure chamber from a plurality of pressure chambers in a single fluid pressure cylinder or a plurality of fluid pressure cylinders associated with each other. Then, the flow control valves are controlled by the control device 5. The selected input pressure chamber and the source of supply SR are communicated with each other, and the selected output pressure chamber and the destination of supply SD are connected with each other. As a result, an output pressure including a pressure higher than an input pressure and a pressure lower than an input pressure can be continuously supplied to the destination of supply SD. Additionally, the hydraulic pressure increasing/decreasing machines 100, 100A and 100B can be miniaturized by the use of the hydraulic cylinders 1 and 2, and can improve an energy efficiency and controllability as compared to a case where the output pressure is adjusted using a pressure-decreasing valve.

Additionally, the hydraulic pressure increasing/decreasing machines 100, 100A and 100B can continuously supply an output pressure equal to an input pressure to the destination of supply SD.

The hydraulic pressure increasing/decreasing machines 100, 100A and 100B are provided with a plurality of combinations of at least one pressure chamber used as an input pressured chamber and at least one pressure chamber used as an output pressure chamber. Thereby, pressure conversion ratios of a plurality of stages can be switchably provided. As a result, the hydraulic pressure increasing/decreasing machines 100, 100A and 100B can supply an output pressure needed by the destination of supply SD in a case where the pressure (input pressure) at the source of supply SR and the pressure (output pressure) needed by the destination of supply SD are different from each other.

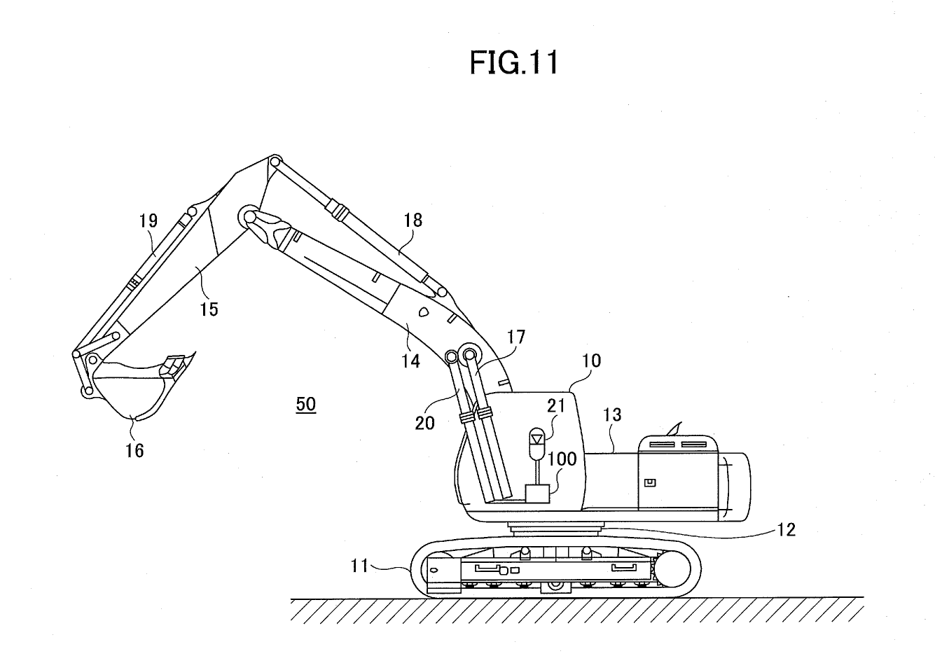

Next, a description will be given, with reference to FIG. 11, of a shovel 50 as a working machine to which the hydraulic pressure increasing/decreasing machine 100 according to the embodiment of the present invention is mounted. FIG. 11 is an outline side view of the shovel 50. The shovel 50 is equipped with an accumulator 21, which recovers a potential energy of a work body such as a boom 14 by converting the potential energy into a fluid pressure energy and makes the recovered fluid pressure energy to be usable for a drive of the work body.

As illustrated in FIG. 11, an upper turning body 13 is mounted on a lower running body 11 of the shovel 50 via a turning mechanism 12.

A boom 14 is attached to the upper turning body 13. An arm 15 is attached to an end of the boom 14. A bucket 16 is attached to an end of the arm 15. The boom 14, the arm 15 and the bucket 16 together configure an excavation attachment, and are hydraulically driven by a boom cylinder 17, an arm cylinder 18 and a bucket cylinder 19, respectively. The hydraulic drive of the boom 14 by the boom cylinder 17 is assisted by an assist cylinder 20. In this case, the boom cylinder 17, which is an object to assist by the assist cylinder 20, is referred to as a main cylinder. It should be noted that the main cylinder may be other hydraulic cylinders such as the arm cylinder 18 or the like. That is, the assist cylinder 20 can assist the hydraulic drive of other work bodies such as the arm 15 or the like.

Moreover, the upper turning body 13 is provided with a cabin 10 at a front part thereof, and an engine (not illustrated in the figure) as a drive source is mounted at a rear part thereof. Additionally, a hydraulic pump (not illustrated in the figure) driven by the engine and a control valve (not illustrated in the figure) controlling a flow of the hydraulic oil discharged by the hydraulic pump are mounted on the upper tuning body 13. The control valve controls a flow of the hydraulic oil flowing in and out of various hydraulic actuators such as the boom cylinder 17, the arm cylinder 18, the bucket cylinder 19, etc.

Further, the accumulator 21, which recovers a potential energy of the boom 14 as a fluid pressure energy and make the recovered fluid pressure energy to be usable for driving the assist cylinder 20, is mounted on the upper turning body 13. The accumulator 21 is connected to the assist cylinder 20 via the hydraulic pressure increasing/decreasing machine 100. Specifically, the accumulator 21 receives the hydraulic oil flowing out of the assist cylinder 20 when the boom 14 is moved downward, and discharges the received hydraulic oil to the assist cylinder 20 when the boom 14 is moved upward.

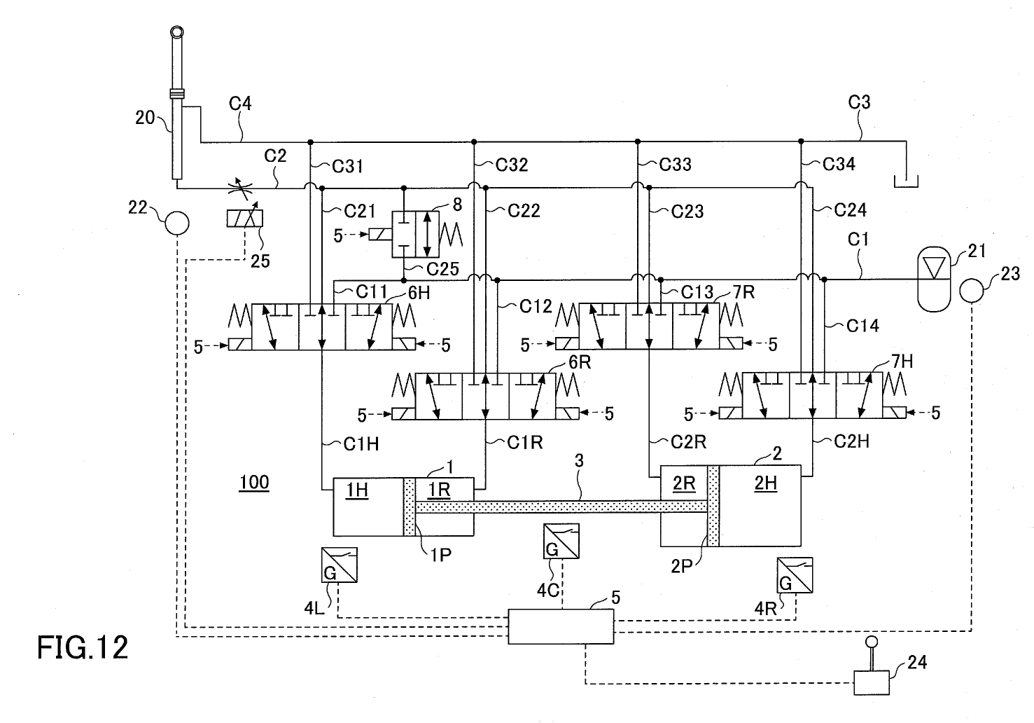

Next, a description will be given, with reference to FIG. 12, of an operation of the hydraulic pressure increasing/decreasing machine 100 mounted on the shovel 50. FIG. 12 is a hydraulic circuit diagram of the hydraulic pressure increasing/decreasing machine 100 mounted on the shovel 50. Because a large part of the hydraulic circuit diagram of FIG. 12 is common to the hydraulic circuit diagram of FIG. 1, a description is given of different parts in detail while omitting a description of the common part.

In FIG. 12, the accumulator 21 as a source of supply of an input pressure is connected to an input of the hydraulic pressure increasing/decreasing machine 100, and a head-side pressure chamber of the assist cylinder 20 as a destination of supply of an output pressure is connected to an output thereof via a pressure decreasing valve 25. It should be noted that a rod-side pressure chamber of the assist cylinder 20 is connected to the hydraulic oil tank via a pipe conduit C4 and a pipe conduit C3. Additionally, a head-side pressure chamber of the assist cylinder 20 is a pressure chamber having a volume increasing when the boom 14 moves upward, and a rod-side pressure chamber is a pressure chamber having a volume decreasing when the boom 14 moves upward.

A postural state detection device 22 is a device for detecting a postural state of the shovel 50. The postural state detection device 22 includes, for example, cylinder stroke sensors for detecting an amount of stroke (a moving distance from a reference position) of the boom cylinder 17, the arm cylinder 18, the bucket cylinder 19 and the assist cylinder 20, respectively, and output the detected values to the control device 5. Additionally, the postural state detection device 22 may include an inclination sensor for detecting an inclination angle of the shovel 50 with respect to a horizontal plane, and may include a pressure sensor for detecting a pressure of the hydraulic oil in each of various hydraulic cylinders.

An accumulator state detection device 23 is a device for detecting a state of the accumulator 21, and is, for example, a pressure sensor for detecting a pressure of the hydraulic oil in the accumulator, and outputs the detected value to the control device 5.

An operational state detection device 24 is a device for detecting an operational state of the excavation attachment. The operational state detection device 24 is, for example, a lever operation amount detection device for detecting an operating direction and an amount of operation of a lever for operating various working bodies, and outputs the detected result to the control device 5.

A pressure decreasing valve 25 is a valve for adjusting a downward movement assist target driving force by appropriately decreasing the output pressure of the hydraulic pressure increasing/decreasing machine 100, and is controlled by the control device 5. It should be noted that the control device 5 may detect a pressure of the head-side pressure chamber of the assist cylinder 20 and may feedback-control the pressure decreasing valve 25 based on the detected value. The pressure decreasing valve may be a proportional pressure decreasing valve.

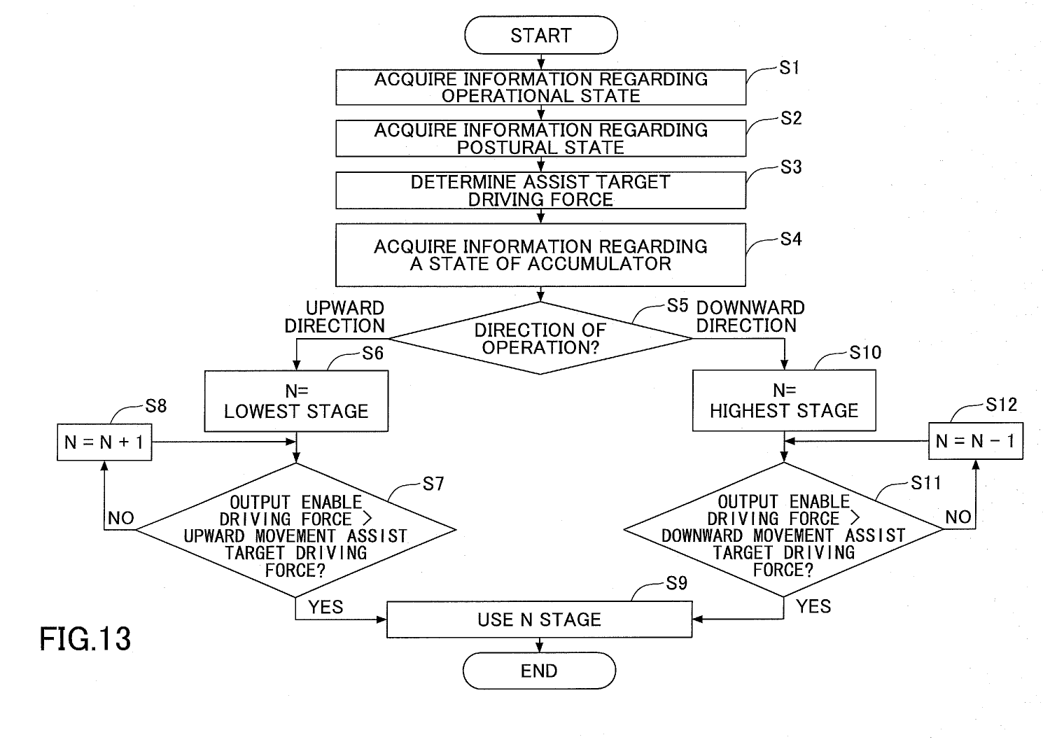

Next a description will be give, with reference to FIG. 13, of a process of the hydraulic pressure increasing/decreasing machine 100 mounted on the shovel 50 to determine stages of the pressure conversion ratio in response to an operation of a boom operation lever. FIG. 13 is a flowchart indicating a flow of a stage determination process. The control device 5 repeatedly performs the stage determination process at a predetermined period when the boom operation lever is operated.

First, the control device 5 acquires information regarding an operation state of the excavation attachment (step S1). Specifically, the control device 5 detects a direction of operation and an amount of operation of each of various levers based on the output of the operational state detection device 24.

Thereafter, the control device acquires information regarding a postural state of the shovel 50 (step S2). Specifically, the control device 5 detects an inclination of the shovel 50 with respect to a horizontal plane and a posture of the excavation attachment based on the output of the postural state detection device 22.

Thereafter, the control device 5 determines an assist target driving force based on the operational state of the excavation attachment and the postural state of the shovel (step S3). Specifically, the control device 5 determines the assist target driving force based on a direction of operation of the boom operation lever, presence of an operation of the arm 15 and bucket 16, an amount of stroke of each of the boom cylinder 17, the arm cylinder 18 and the bucket cylinder 19, and an angle of inclination of the shovel 50 with respect to a horizontal plane.

More specifically, when the arm 15 and the bucket 16 are not operated and the shovel 50 is positioned on a horizontal plane, a downward movement assist target driving force when moving the excavation attachment downward is set to a value substantially equal to a load rest maintaining force, which is a driving force necessary for causing the excavation attachment to rest. Strictly, it is determined to be a value slightly lower than the load rest maintaining force. Moreover, an upward movement assist target driving force when moving the excavation attachment upward is set to a value lower than the load rest maintaining force by a predetermined value. It should be noted that the load rest maintaining force is a previously set value in response to a posture of the excavation attachment.

Thereafter, the control device 5 acquires information regarding a state of the accumulator 21 (step S4). Specifically, the control device 5 acquires a pressure of the hydraulic oil based on the output of the accumulator state detection device 23.

Thereafter, the control device 5 determines a direction of operation of the excavation attachment based on the already acquired information regarding an operational state of the excavation attachment (step S5). Specifically, the control device 5 determines, for example, a direction of operation of the boom operation lever.

If it is determined that the direction of operation of the boom operation lever, that is, the direction of operation of the excavation attachment is an upward direction (upward direction of step S5), the control device 5 sets a value of a parameter N, which represents stages of the pressure conversion ratio, to a minimum stage (for example, −4 stage) (step S6).

Thereafter, the control device 5 computes a driving force according to an output pressure, which the hydraulic pressure increasing/decreasing machine 100 can supply, as an output enabled driving force, when the pressure conversion ratio is a value of N stage, and determines whether or not the output enabled driving force is larger than the upward movement assist target driving force (step S7).

It should be noted that the output enabled driving force is computed, for example, as a value obtained by multiplying the pressure of the hydraulic oil in the accumulator 21 by the pressure conversion ratio of the N stage and the head-side pressure receiving area of the assist cylinder 20

If it is determined that the output enabled driving force is smaller than or equal to the upward movement assist target driving force (YES of step S7), the control device 5 adds a value “1” to the value of the parameter N (step S8). Thereafter, the control device 5 performs the process of step S7 again. That is, after computing the output enabled driving force again, the control device 5 determines whether the output enabled driving force computed again is larger than the upward movement assist target driving force.

As mentioned above, the control device 5 repeats the process of step S7 by increasing the stage by 1 until the output enabled driving force becomes larger than the upward movement assist target driving force.

If it is determined that the output enabled driving force is larger than the upward movement assist target driving force (YES of step S7), the control device determines that the stage indicated by the value of the parameter N at that time is a stage actually used (step S9), and operates the hydraulic pressure increasing/decreasing machine 100 so that an output pressure is created according to the pressure conversion ratio at the N stage.

On the other hand, if it is determined that the direction of operation of the boom operation lever, that is, the direction of operation of the excavation attachment is a downward direction (downward direction in step S5), the control device 5 sets the value of the parameter N, which represents a stage of the pressure conversion ratio) to a highest stage (for example, +4 stage) (step S10).

Thereafter, the control device 5 computes the output enabled driving force when the pressure conversion ratio is set to the value of N stage, and determines whether the output enabled driving force is lower than the downward movement assist target driving force (step S11).

If it is determined that the output enabled driving force is larger than or equal to the downward movement assist target driving force (NO of step S11), the control device 5 subtracts a value “1” from the value of the parameter N (step S12). Thereafter, the control device 5 performs the process of step S11 again. That is, after computing the output enabled driving force again, it is determined whether the output enabled driving force computed again is lower than the downward movement assist target deriving force.

As mentioned above, the control device 5 repeats the process of step S11 by decreasing the stage one by one until the output enabled driving force becomes lower than the downward movement assist target drive force.

If it is determined that the output enabled driving force is lower than the downward movement assist target driving force (YES of step S11), the control device 5 determines that the stage indicated by the value of the parameter N at that time is a stage actually used (step S9), and operates the hydraulic pressure increasing/decreasing machine 100 so that an output pressure is created according to the pressure conversion ratio at the N stage.

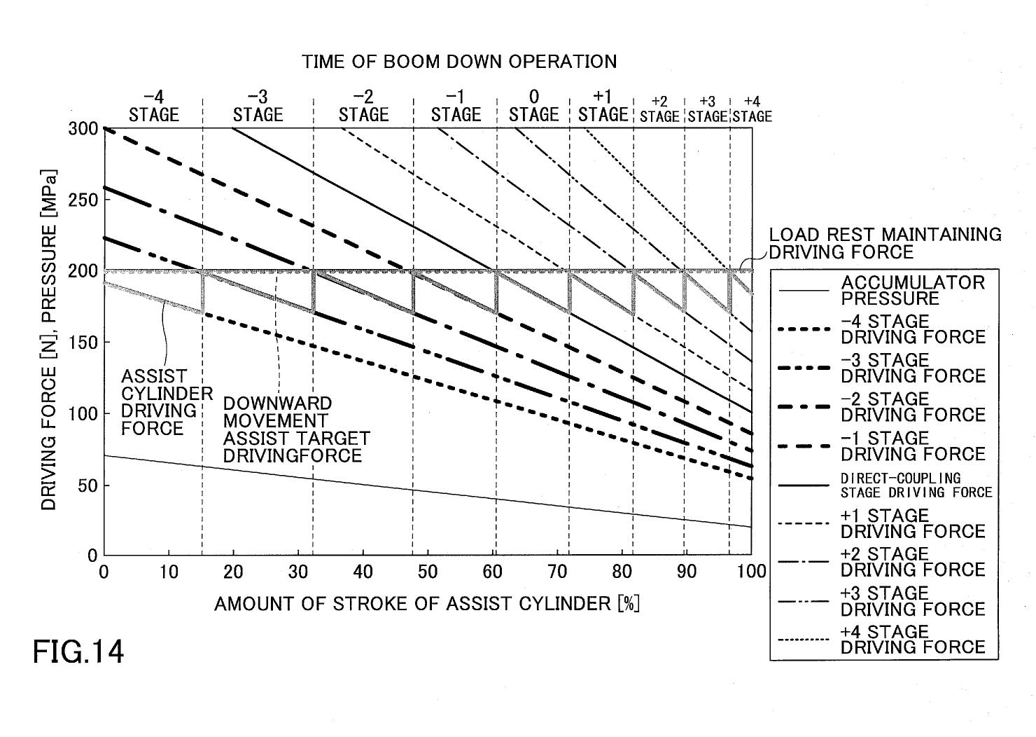

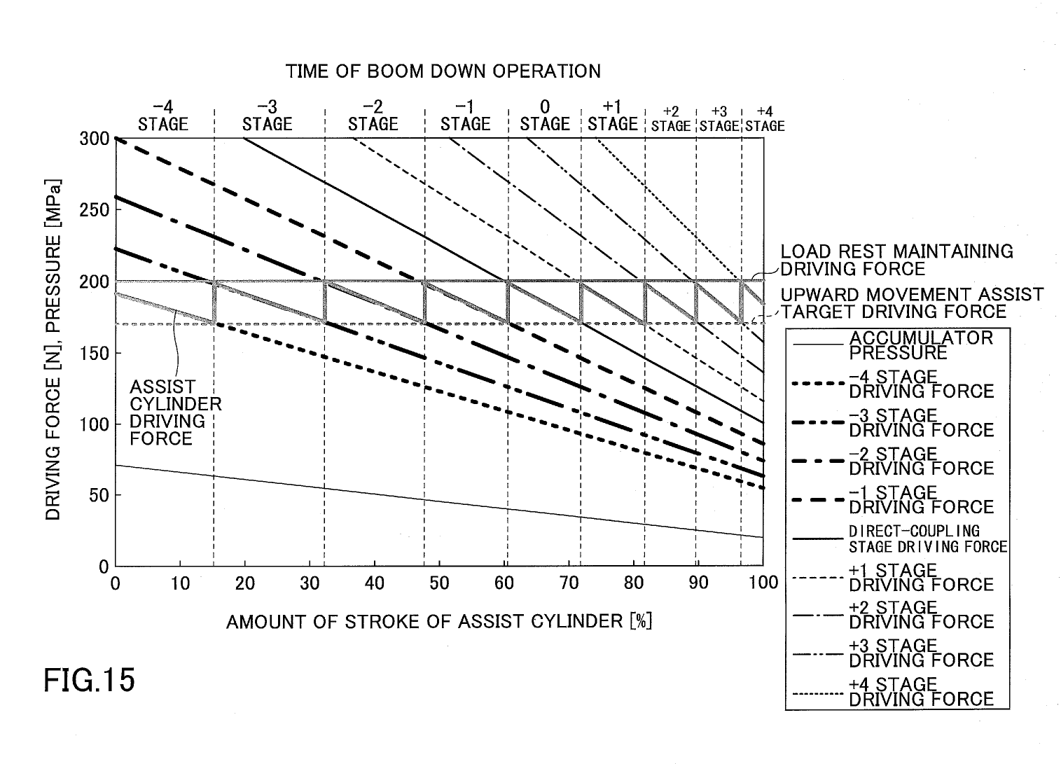

Next, a description will be given, with reference to FIG. 14 and FIG. 15, of a correspondence relationship between an amount of stroke of the assist cylinder 20, an input pressure and an output pressure of the hydraulic pressure increasing/deceasing machine 100, each driving force, and a used stages of the hydraulic pressure increasing/decreasing machine 100. FIG. 14 is an illustration indicating a correspondence relationship at a time of a boom down operation. FIG. 15 is an illustration indicating a correspondence relationship at a time of a boom up operation. Additionally, both FIG. 14 and FIG. 15 indicate a correspondence relationship when the atm 15 and the bucket 16 are not operated and the shovel 50 is positioned on a horizontal plane.

An amount of stroke of the assist cylinder 20 arranged on a horizontal axis represents a state where the assist cylinder 20 retracts utmost by 0 [%] (a state where the boom 14 is moved downward at the maximum), and represents a state where the assist cylinder extends utmost (a state where the boom 14 is moved upward at the maximum) by 100 [%].

Moreover, a transition indicated by a thin solid line represents a transition of a pressure of the hydraulic oil in the accumulator 21, and a transition indicated by a bold solid line represents a transition of the output enabled driving force (output pressure×pressure receiving area)) at a time of direct-coupling (0 stage). The output pressure at the time of direct-coupling corresponds to an input pressure, that is, an accumulator pressure. Additionally, the accumulator pressure is in a relationship of reverse proportional to an amount of stroke of the assist cylinder 20, and decreases as the amount of stroke increases. Transitions indicated by a bold dashed line, a bold single dashed chain line, a bold double dashed chain line and a bold dotted line represent transitions at a time of −1 stage, −2 stage, −3 stage and −4 stage, respectively. Additionally, a thin dashed line, a thin single dashed chain line, a thin double dashed chain line and a thin dotted line represent transitions at a time of +1 stage, +2 stage, +3 stage and +4 stage, respectively.

A transition indicated by a gray line extending parallel to the horizontal axis represents a transition of a load rest maintaining driving force. It should be noted that although the load rest maintaining driving force is actually not constant, here for the sake of convenience, the load rest maintaining driving force is recited to be constant irrespective of an amount of stroke of the assist cylinder 20, that is, irrespective of a position of the boom 14. Moreover, a transition indicated by a dotted gray line extending parallel to the horizontal axis represents a transition of the downward movement assist target driving force, and illustrates that the downward movement assist target driving force transits at a level slightly lower than the load rest maintaining driving force. Additionally, a transition indicated by a saw-like gray line represents a transition of driving force assumed by the output pressure from the hydraulic pressure increasing/decreasing machine 100, which determines a used stage according to a stage determination process. It should be noted that values of the stages indicated in an upper portion of the graph area a relationship between the used stage and an amount of stroke of the assist cylinder 20, and, for example, −1 stage is used when an amount of stroke is 50 [%].

Using the correspondence relationship indicated in FIG. 14, the control device 5 determines a stage to be used at the time of boom down operation. Specifically, first, the control device 5 derives an output enabled driving force (275 [N]) at +4 stage, that is specified by a present amount of stroke of the assist cylinder 20 (for example, 80 [%]) and the thin dotted line representing a transition of the output enabled driving force at +4 stage, which is the highest stage. Then, the control device 5 deteunines that the derived output enabled driving force (275 [N]) is larger than the downward movement assist target driving force (199 [N]).

Thereafter, similar to the above-mentioned, the control device 5 sequentially derives the output enabled driving force at +3 stage (240 [N]) and the output enabled driving force at +2 stage (205 [N]). In either case, the control device 5 determines that the derived output enabled driving force is larger than the downward movement assist target driving force (199 [N]).

Thereafter, the control device 5 derives the output enabled driving force (175 [N]) at +1 stage, which is a next highest stage. In this case, the control device 5 determines that the derived output enabled driving force (175 [N]) is smaller than the downward movement assist target driving force (199 [N]). Then, the control device 5 determines the +1 stage as an actually used stage.

As mentioned above, the control device 5 determines an appropriate stage by which the boom 14 can be moved downward smoothly while preventing the downward movement of the boom 14 from being stopped or being changed to an upward movement due to an upward movement driving force by the assist cylinder 20.

In the boom down operation, the hydraulic oil flowing out of the head-side pressure chamber of the assist cylinder 20 flows into the output pressure chamber through the pipe conduit C2, and the hydraulic oil flowing out of the input pressure chamber flows into the accumulator, 21 through the pipe conduit C1. The hydraulic pressure increasing/decreasing machine 100 changes the pressure conversion ratio (stage) in response to a decrease in an amount of stroke of the assist cylinder 20, as illustrated in FIG. 14, so as to gradually increase the pressure of the hydraulic oil in the accumulator 21, that is, the pressure at the input of the hydraulic pressure increasing/decreasing machine 100. This is to enable the hydraulic oil to be pressed into the accumulator 21 of which a pressure inside thereof gradually increases. In this case, the driving force according to the pressure of the hydraulic oil in the head-side pressure chamber of the assist cylinder 20, that is, the driving force according to the output pressure of the hydraulic pressure increasing/decreasing machine 100 is maintained within a predetermined range, as illustrated by a saw-like gray line of FIG. 14, by the pressure of the hydraulic oil in the head-side pressure chamber of the assist cylinder 230 being adjusted appropriately by the pressure decreasing valve 25 controlled by the control device 5.

Using the correspondence relationship indicated in FIG. 15, the control device 5 determines a stage to be used at the time of boom up operation. Specifically, first, the control device 5 derives an output enabled driving force (125 [N]) at −4 stage that is specified by a present amount of stroke of the assist cylinder 20 (for example, 50 [%]) and the bold dotted line representing a transition of the output enabled driving force at −4 stage, which is the lowest stage. Then, the control device 5 determines that the derived output enabled driving force (125 [N]) is smaller than the upward movement assist target driving force (170 [N]).

Thereafter, similar to the above-mentioned, the control device 5 sequentially derives the output enabled driving force at −3 stage (145 [N]) and the output enabled driving force at −2 stage (165 [N]). In either case, the control device 5 determines that the derived output enabled driving force is smaller than or equal to the upward movement assist target driving force (170 [N]).

Thereafter, the control device 5 derives the output enabled driving force (190 [N]) at −1 stage, which is a next highest stage. In this case, the control device 5 determines that the derived output enabled driving force (190 [N]) is larger than the upward movement assist target driving force (170 [N]). Then, the control device 5 determines the −1 stage as an actually used stage.

As mentioned above, the control device 5 determines an appropriate stage by which the boom 14 can be moved upward smoothly by assisting the upward movement of the boom 14 by the boom cylinder 17 while preventing the upward movement driving force by the assist cylinder 20 being in short supply excessively.

In the boom up operation, the hydraulic oil flowing out of the accumulator 21 flows into the input pressure chamber through the pipe conduit C1, and the hydraulic oil flowing out of the output pressure chamber flows into the head-side pressure chamber of the assist cylinder 20 through the pipe conduit C2. The hydraulic pressure increasing/decreasing machine 100 changes the pressure conversion ratio (stage) in response to an increase in an amount of stroke of the assist cylinder 20, as illustrated in FIG. 15, so as to maintain the driving force by the pressure of the hydraulic oil in the head-side chamber of the assist cylinder 20, that is, the driving force due to the output pressure of the hydraulic pressure increasing/decreasing machine 100 to be within a predetermined range as indicated by the saw-like gray line of FIG. 15 by the pressure of the hydraulic oil in the head-side pressure chamber of the assist cylinder 20 being appropriately adjusted by the pressure decreasing valve 25 controlled by the control device 5. In this case, the pressure of the hydraulic oil in the accumulator 21, that is, the input pressure of the hydraulic pressure increasing/decreasing machine 100 gradually decreases. This is because the hydraulic oil in the accumulator 21 is discharged.

The control device 5 may directly determine a used stage based on an amount of stroke of the assist cylinder 20 without individually computing the output enabled driving force of each stage by storing an amount of stroke of the assist cylinder 20 and a used stage by being associated with each other.

Although in the present embodiment the control device 5 used the same correspondence relationship at the time of a boom up operation and at the time of a boom down operation except for setting of the assist target driving force as illustrated in FIG. 14 and FIG. 15, different correspondence relationships may be used.

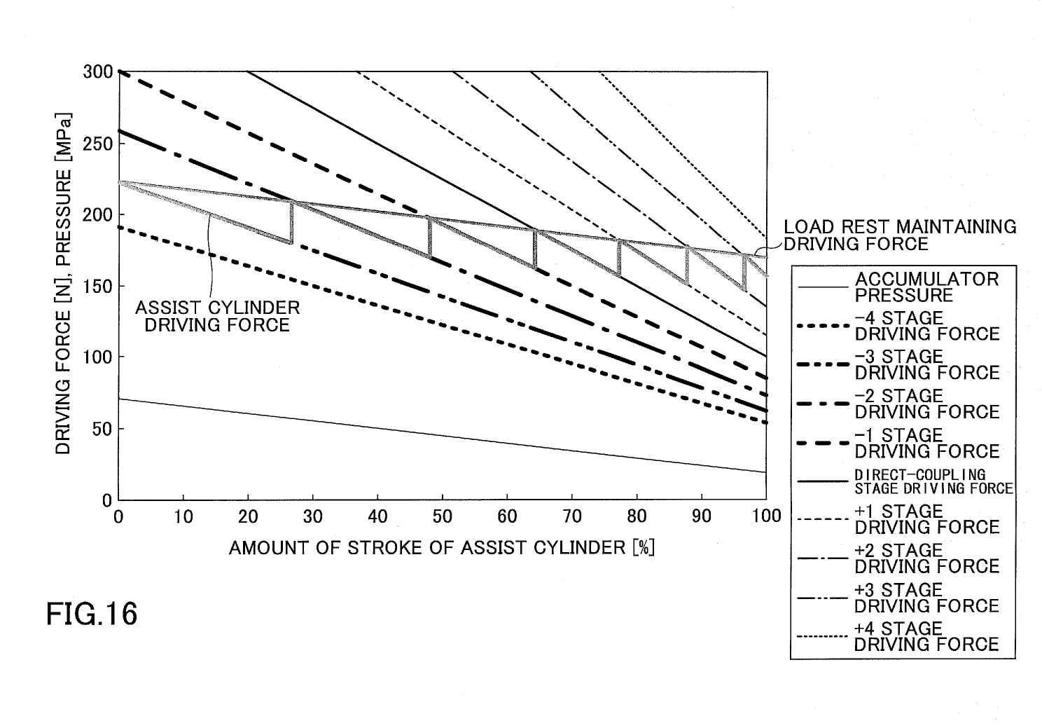

Next, a description will be given, with reference to FIG. 16, of a correspondence relationship between an amount of stroke of the assist cylinder 20, an input pressure and an output pressure of the hydraulic pressure increasing/decreasing machine 100 and a used stage of the hydraulic pressure increasing/decreasing machine 100 in a case where the arm 15 and the bucket 16 are operated or the shovel 50 is inclined with respect to the horizontal plane. It should be noted that the correspondence relationship illustrated in FIG. 16 differs from the correspondence relationship illustrated in FIG. 14 and FIG. 15 in a point that the load rest maintaining driving force that is set to decrease as an increase in an amount of stroke of the assist cylinder 20 is used. Additionally, the correspondence relationship illustrated in FIG. 16 is used in both the time of the boom up operation and the time of the boom down operation except for the setting of the assist target driving force, and, for example, used in a combination operation to close an arm while moving the boom upward, a combination operation to open an arm while moving a boom downward, or an operation of moving a boom upward and downward by the shovel 50 in a posture of inclining forward.

Also in the correspondence relationship illustrated in FIG. 16, the control device 5 determines, in the time of a boom down operation, an appropriate stage by which the boom 14 can be moved downward smoothly while preventing the downward movement of the boom 14 from being stopped or being changed to an upward movement due to an upward movement driving force by the assist cylinder 20 in the time of the boom down operation. Additionally, the control device 5 determines, in the time of a boom up operation, an appropriate stage by which the boom 14 can be moved upward smoothly by assisting the upward movement of the boom 14 by the boom cylinder 17 while preventing the upward movement driving force by the assist cylinder 20 being in short supply excessively.

According to the above-mentioned structure, the hydraulic pressure increasing/decreasing machine 100 can control more flexibly the pressure of the hydraulic oil pressed into the assist cylinder 20, and can control more flexibly an operation of the assist cylinder 20, consequently an operation of the excavation attachment. That is, an operability of the excavation attachment and a use efficiency of hydraulic energy recovered by the accumulator 21 can be improved.

The hydraulic pressure increasing/decreasing machine 100 can control more flexibly the pressure of the hydraulic oil pressed into the accumulator 21, and can control more flexibly the recovery of a potential energy of the excavation attachment by the accumulator 21. That is, a recovery efficiency of a potential energy by the accumulator 21 can be improved.

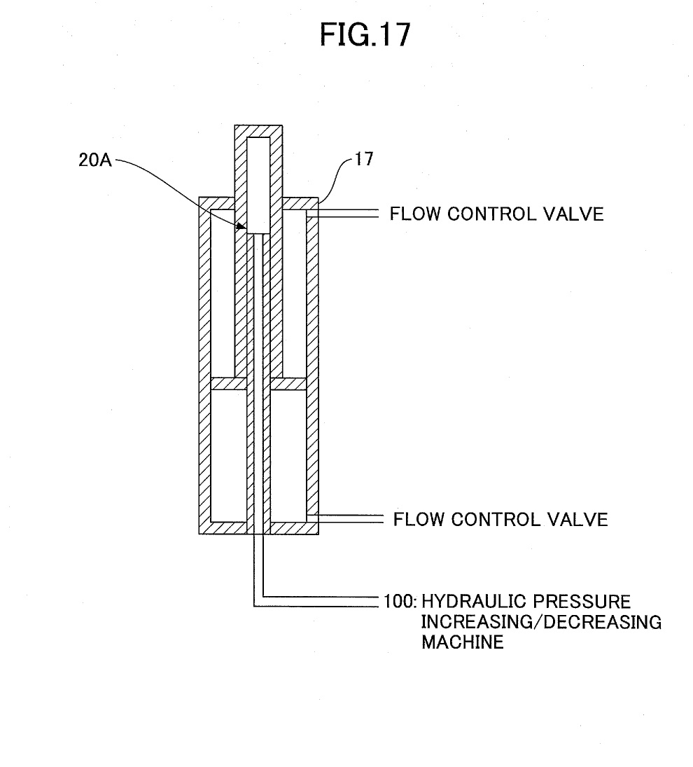

Next, a description will be given, with reference to FIG. 17, of an assist cylinder 20A having another structure. FIG. 17 is a cross-sectional view of the boom cylinder 17 including the assist cylinder 20A. FIG. 17 illustrates a state where the assist cylinder 20A is formed in the piston rod of the boom cylinder 17 as a main cylinder, which is a target for assist.

The assist cylinder 20A has a single port through which the hydraulic oil flows out or flows in, and the port is connected to the output of the hydraulic pressure increasing/decreasing machine 100. It should be noted that each of the head-side pressure chamber and the rod-side pressure chamber of the boom cylinder 17 is connected to a flow control valve not illustrated in the figure so that the hydraulic oil discharged by a hydraulic pump not illustrated in the figure can be received and the hydraulic oil can be discharged toward the hydraulic oil tank. It should be noted that the input of the hydraulic pressure increasing/decreasing machine 100 is connected to the accumulator 21.

Also according to the above-mentioned structure, the hydraulic pressure increasing/decreasing machine 100 can control more flexibly the pressure of the hydraulic oil pressed into the assist cylinder 20A, and can control more flexibly an operation of the assist cylinder 20A, consequently an operation of the excavation attachment. That is, an operability of the excavation attachment and a use efficiency of hydraulic energy recovered by the accumulator 21 can be improved.

The hydraulic pressure increasing/decreasing machine 100 can control more flexibly the pressure of the hydraulic oil pressed into the accumulator 21, and can control more flexibly the recovery of a potential energy of the excavation attachment by the accumulator 21. That is, a recovery efficiency of a potential energy by the accumulator 21 can be improved.

Although descriptions have been given of preferred embodiments, the present invention is not limited to the above-mentioned embodiments, and various modifications and replacements can be made to the above-mentioned embodiments without departing from the scope of the present invention.

For example, in the above-mentioned embodiments, the hydraulic oil may be replaced by other fluids such as air, water, etc.

Moreover, although the assist cylinder 20 is attached in front of and parallel to the boom cylinder 17 in the above-mentioned embodiments, the assist cylinder 20 may be attached behind and parallel to the boom cylinder 17. Additionally, the assist cylinder 20 may be attached in front of, on a side of or behind the boom cylinder 17 while being inclined to the boom cylinder 17.

Moreover, the assist cylinder 20 may be attached behind the boom 14, that is, on an opposite side to the boom 14 with respect to the boom cylinder 17, which is attached in front of the boom 14. In this case, the assist cylinder 20 extends as the boom 14 moves downward, and retracts as the boom 14 moves upward. Thus, the rod-side pressure chamber of the assist cylinder 20 is connected to the output pressure chamber of the hydraulic pressure increasing/decreasing machine 100, and the head-side pressure chamber of the assist cylinder 20 is connected to the hydraulic oil tank.

Moreover, the hydraulic pressure increasing/decreasing machine 100 may be mounted to other working machines, such as a hydraulic elevator, a hydraulic crane, etc., that have an accumulator capable of recovering a potential energy of a work body as a fluid pressure energy and a fluid pressure actuator capable of driving a work body using the fluid pressure energy of the accumulator.

What is claimed is:

1. A fluid pressure increasing/decreasing machine capable of continuously supplying an output pressure to an external destination of supply by converting an input pressure supplied from an external source of supply, the fluid pressure increasing/decreasing machine comprising:
a control device selecting at least one input pressure chamber and at least one output pressure chamber from among at least three pressure chambers in a fluid pressure cylinder or a plurality of fluid pressure cylinders operating inter-connectedly, the input pressure chamber being supplied with the input pressure, the output pressure chamber creating the output pressure including a pressure higher than the input pressure and a pressure lower than the input pressure; and
a flow control valve controlled by the control device to cause the selected input pressure chamber to communicate with the external source of supply, and cause the selected output pressure chamber to communicate with the external destination of supply,
wherein at least one of the pressure chambers is capable of being either of the input pressure chamber and the output pressure chamber.

2. The fluid pressure increasing/decreasing machine as claimed in claim 1, further comprising an input/output direct-coupling switch valve capable of directly coupling the external source of supply and the external destination of supply.

3. The fluid pressure increasing/decreasing machine as claimed in claim 1, wherein a pressure conversion ratio, which is a ratio of an output pressure to an input pressure, is set in a plurality of stages, and an arrangement of the pressure conversion ratios in the respective plurality of stages forms an arithmetic progression or a geometric progression.

4. The fluid pressure increasing/decreasing machine as claimed in claim 1, further comprising a piston position detector that detects a position of a piston in the at least one fluid pressure cylinder or the plurality of fluid pressure cylinders operating inter-connectedly.

5. The fluid pressure increasing/decreasing machine as claimed in claim 1, wherein the plurality of cylinders operating inter-connectedly include a common rod causing respective pistons to move together in one piece.

6. A working machine comprising:
a main cylinder driving a work body;
an assist cylinder assisting the main cylinder;
an accumulator recovering a potential energy of the work body as a fluid pressure energy, and allowing the recovered fluid pressure energy to be used for driving the assist cylinder; and
a fluid pressure increasing/decreasing machine capable of continuously supplying an output pressure to an external destination of supply by converting an input pressure supplied from an external source of supply, the fluid pressure increasing/decreasing machine including: a control device selecting at least one input pressure chamber and at least one output pressure chamber from among at least three pressure chambers in a fluid pressure cylinder or a plurality of fluid pressure cylinders operating inter-connectedly, the input pressure chamber being supplied with the input pressure, the output pressure chamber creating the output pressure including a pressure higher than the input pressure and a pressure lower than the input pressure; and a flow control valve controlled by the control device to cause the selected input pressure chamber to communicate with the external source of supply, and cause the selected output pressure chamber to communicate with the external destination of supply,
wherein at least one of the pressure chambers is capable of being either of the input pressure chamber and the output pressure chamber, and
the fluid pressure increasing/deceasing machine sets the accumulator as the external source of supply and sets the assist cylinder as the external destination of supply.

7. The working machine as claimed in claim 6, wherein the assist cylinder is formed in a piston rod of the main cylinder.

8. A fluid pressure increasing/decreasing machine capable of continuously supplying an output pressure to an external destination of supply by converting an input pressure supplied from an external source of supply, the fluid pressure increasing/decreasing machine comprising:
a control device selecting at least one input pressure chamber, at least one output pressure chamber and at least one different pressure chamber from among at least three pressure chambers in a fluid pressure cylinder or a plurality of fluid pressure cylinders operating inter-connectedly, the input pressure chamber being supplied with the input pressure, the output pressure chamber creating the output pressure including a pressure higher than the input pressure and a pressure lower than the input pressure, the different pressure chamber being supplied with a pressure different from the input pressure and the output pressure; and
a flow control valve controlled by the control device to cause the selected input pressure chamber to communicate with the external source of supply, and cause the selected output pressure chamber to communicate with the external destination of supply,
wherein at least one of the pressure chambers is capable of being either of the input pressure chamber and the output pressure chamber.
